(19) United States
(12) Patent Application Publication
(10) Pub. No.: US 2006/0224946 A1
(43) Pub. Date: Oct. 5, 2006

(54) Spreadsheet programming

(75) Inventors: Robert C. Barrett, Durham (GB); Eben M. Haber, Cupertino, CA (US); Eser Kandogan, Mountain View, CA (US); Paul P. Maglio, Catheys Valley, CA (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: International Business Machines Corporation, Armonk, NY (US)

(21) Appl. No.: 11/095,119

(22) Filed: Mar. 31, 2005

(51) Int. Cl. G06F 15/00; G06F 17/00; G06F 17/21

(52) U.S. Cl. 715/503

(57) ABSTRACT

Spreadsheet programming model and language is extended to create objects, with their associated state and set of defined behaviors, as first-class spreadsheet cell residents. Desired object behaviors can be invoked by calling methods on the objects through an event-based imperative programming language that potentially modifies the state of an object. Expressions can also be defined by calling methods on objects that produce new objects in combination with operations on objects in other cells. Programming constructs are defined that allows users to perform a sequence of operations on one or more objects. Operations can also be performed automatically similar to spreadsheet triggering mechanism. Users can program to trigger operations either manually or automatically based on changes to objects, or based on conditions defined.

### BACKGROUND OF THE INVENTION

1. Field of the Invention

This invention involves the development of an object-oriented model and event-based imperative language for spreadsheet programming that is extended to create objects, with their associated state and set of defined behaviors, as first-class spreadsheet cell residents.

2. Description of the Related Art

Within this application several publications are referenced by arabic numerals within parentheses. Full citations for these, and other, publications may be found at the end of the specification immediately preceding the claims. The disclosures of all these publications in their entireties are hereby expressly incorporated by reference into the present application for the purposes of indicating the background of the present invention and illustrating the state of the art.

Due to the size, complexity and unique configurations of the particular systems that various system administrators manage, they often depend on customized software programming to efficiently do their work. Examples of custom software include such things as: (1) a script that adds a new user and password to three server operating systems, a database, and an email system; (2) a batch process that runs every hour to collect run-time diagnostics from a web server and database and posts the results to a web page and notifies/warns system administrator of diagnostics above a threshold through email; (3) a series of commands for modifying a database configuration according to a requested change by the system administrator's team lead. It is not possible for the particular IT components' product developers to include features for accomplishing all of these tasks within their products for two reasons: (1) the required sequence of operations is quite idiosyncratic and depends strongly on the particular needs of the particular system administrator, IT infrastructure, or organization/business concerns and practices; and/or (2) the operations span multiple components (such as a database and a web server) that were not designed to be controlled by a single user-interface. In other words, in many cases the software vendors cannot predict ahead-of-time what particular operations a system administrator will want to perform upon systems. As a result, system administrators often write their own customized software programs (often referred to as a “scripts”) for performing such tasks.

Since system administrators are primarily concerned with IT system operations (i.e., keeping operational IT systems up-and-running and updated according to the changing needs of their business) rather than with software development (i.e., the specification, implementation, testing, and packaging of software for distribution to customers), the typical tools that have been developed for software development are not well-suited to the needs of system administrators. The invention is a software development and execution environment that is specifically designed for system administrators. The invention is based on the idea of a spreadsheet, which is a common “programming” environment for business users and other users who are not professional software developers. The invention extends the idea of a spreadsheet beyond its normal capabilities by providing a language with commands for controlling and expressions for querying IT components by representing such components as objects in the cells of the spreadsheet.

Thus the inventive spreadsheet can be used by system administrators to develop customized “programs” (or spreadsheets) that can monitor and configure IT systems. Furthermore, the invention provides the capability of executing these spreadsheets, deploying them to web servers for future use, and sharing the spreadsheets between users.

In this case some system administrators (Author) develop code for creating objects, defining expressions, and executing commands that realize the inventive application. The inventive application is then exported as a portal-based web application. Once exported, other system administrators (User) can then run the same application through a web browser, monitoring and managing backend IT Systems. Other systems administrators (User) may also decide to modify the behavior of the deployed web application, by editing its code from the portal to customize the application for their own use, essentially assuming the role of an Author.

Such custom programs can also be developed by other companies such as Internet Software Vendors (ISV) and Value Added Resellers (VAR) providing services to customers. It is in the interest of such companies to rapidly develop custom solutions for their customers where tools are developed and customized specifically based on each customer's needs.

System administrators use a variety of tools in order to accomplish their tasks. Some are standard office tools that are typical for knowledge workers, while others are highly specific to the job of system administration. Just like many other office workers, they use standard productivity tools, system administrators use the standard communication tools of telephone, pagers, email, instant messaging, and screen sharing, and shared calendars. They use standard office productivity software tools such as a word processor, spreadsheet, business visualization tool (such as Microsoft Visio), and a presentation package. They also rely upon corporate directory systems in order to find colleagues of interest. Standard information tools, such as the world-wide web, search engines such as Google (www.google.com), and a wide-range of technical information tools such as manuals and reference guides (both online and paper) are critical in their activities. Like many workers whose time is charged against various customer accounts, they use a time-card logging tool. More specific system administrator tools include workflow systems that track proposed system changes, requests for signoffs, authorization, scheduling, procedure logging, and completion records. Then, most specifically, system administrators use tools that allow actual access and control to the systems they are responsible for administering. These tools can be highly generic, such as telnet, ftp, grep and many other Unix command-line tools. They also include very specific tools for the systems they manage, such as the IBM DB2 Control Center for database management, and the IBM WebSphere Application Server administrative console.

The software tools that system administrators use can be divided by the type of interaction they afford with the system administrator. Some tools use a command-line interface (CLI), which afford a textual command-response interface where the system administrator types a command and then receives a response back from the system. For long-running commands, the system administrator can place the task into the background and perform other commands. It is not uncommon for system administrators to have multiple command-line consoles open at once on their computer desktop which are connected to a variety of remote computers which are being used by the system administrator for a variety of purposes. For example, a system administrator might have one console connected to a test server and another connected to the production server. Or, a system administrator might have three consoles connected to the same server with one monitoring the current system state, another running a long-running task, and a third available for looking up commands quickly. CLIs are often the preferred interfaces for system administrators because of their minimal requirements, flexibility, reliability, and “close to the system” feel.

Other software tools use graphical user interfaces (GUIs), which afford interactions through pointing and clicking on graphical objects, such as buttons, checkboxes, and others. These interfaces are often more intuitive and easier than CLIs for less familiar tasks, but are often perceived to be slow, unreliable, complex, and inflexible. If a GUI tool is particularly well-designed or very well-suited for a particular task that the system administrator has to perform often, then the tool can become highly prized.

Still, other software tools are based on a web browser interaction model with forms and hyperlinks. These tools can be as easy to use as the GUI tools. Yet, they can also have minimal system requirements like CLI tools because the remote system does not need any graphical capabilities since the client's web browser manages the graphics of the interface. Web-based tools also often allow access from any computer on the network that is equipped with a web browser, which can be convenient, especially for sharing tools among system administrators.

Another important point about system administrator tools is that for many system administrators, no suite of vendor-supplied tools can satisfy their needs. Many system administrators find that they must supplement their supplied tools with additional tools that are built in-house, either by the system administrator himself or herself, by a system administrator colleague, or by a development group within the enterprise that supports the work of system administrators.

Spreadsheets are popular analysis tools for end-users of various professional backgrounds. Success of spreadsheets is typically attributed to their cognitive, motivational, and social advantages (Nardi and Miller, 1990 [1]). The spreadsheet programming language and execution model is fairly straightforward and flexible. Users can easily create sheets without significant cognitive demand. Essentially, a spreadsheet is composed of cells organized in a tabular form. Users can input data such as numbers and text and functions which are simply expressions of functional dependencies into cells. Users do not have to declare a name and type for the data or function entered, unlike most programming languages.

The spreadsheet execution model is also quite simple. Essentially, when data change cells that are functionally dependent will be automatically reevaluated. In some sense users are always dealing with up-to-date state of the sheet. This feature turns out to be quite motivating, as it allows users to progressively build working sheets and provides positive feedback on the correctness of the sheet to continue building more. Furthermore, this also makes spreadsheets resilient as an error in one cell only affects referring cells and does not necessarily invalidate the entire sheet, or crash the software totally. Most spreadsheets provide a variety of visualizations that allow users to examine their data in visual form. This in many ways makes spreadsheets compelling since they facilitate a nice integration of textual input for expressions and graphical output for data representation.

Spreadsheet typically rely on an easy-to-understand direct programming interface in which code and data are closely associated, allowing users to click on a cell to see its code and understand how it works. This in fact supports users share sheets easily and modify them for their own use. Spreadsheets typically support a copy and paste functionality which allows users to quickly copy and paste expressions where data references in expressions are updated based on the relative location of the cells. This further makes spreadsheets more efficient and flexible. In short, the success of spreadsheets can be attributed to their reusability, shareability, resilience, and their straightforward application model with direct programming.

This invention involves the development of an object-oriented model and event-based imperative language for spreadsheet programming. Spreadsheets are definitely among the most popular end-user programming languages. Today, spreadsheets are used by millions of users for personal activities such as mortgage calculations as well as professional activities such as business decision making, financial modeling, and corporate accounting.

While it is easy to use to perform large calculations spreadsheets seriously lack in their expressibility and programming power. Many researchers attempted to extend the familiar spreadsheet paradigm to enable more programming capabilities to solve problems beyond simple tabular calculations. The focus of these efforts included but were not limited to reexamining the spreadsheet language, data/cell types, programming model, and the user interface improvements.

Spreadsheets typically employ functions for expressing relationships among data in various cells. For example, to take the average of numbers in cells A1, A2, and A3 into cell B1, the user needs to define the expression=AVERAGE(A1, A2, A3) into cell B1. While many argue that spreadsheet languages are functional the fact is as far as the language constructs are concerned it is merely composed of expressions that can similarly be found in imperative languages. It is the programming model that sets spreadsheets apart from both functional and imperative languages.

The success of spreadsheets as end-user programming environments is primarily due to the simple programming model. Fundamental to this model is a triggering mechanism which automatically reevaluates spreadsheet cell values based on the expressions defined on the cells. In the above example, if the user changes the data in cell A1, expression in cell B1 would automatically trigger due to its implicit dependency on cell A1 by way of the expression in B1.

While the spreadsheet programming model is simple it is restricted in expressive power and computational capabilities. First, the number of data types is quite limited making it hard to build and reuse in high-level solutions. Today, most spreadsheets support a few data types such as numbers, text, and date and a number of functions that make calculations on these data types. Consequently, high-level abstractions can only be represented using multiple cells each showing a different attribute of the abstraction. For example, to represent a car, the user needs to create multiple cells for each attribute of the car, such as year, model, make, and odometer reading. However, there isn't a way to group these cells and identify them as an abstraction, give a name, and use that name in expressions. Last but not least, functions only map data to data. There isn't a way to define behaviors that modify the state of the abstractions. For example, users cannot define a drive behavior where the odometer reading of the car starts increasing.

In most commercially available spreadsheet applications including Excel (Microsoft Corporation, Redmond, Wash.), Lotus 1-2-3 (IBM, White Plans, N.Y.), and Corel Quattro Pro (Corel Corporation, Ontario, Canada) users utilize built-in function to perform calculations on a set of standard data types. While users cannot define new functions, macros provide some level of programmability. There are no local variables nor can users specify parameters to formulas. Macros are essentially language extensions that provide sequential operations and high level language constructs such as iteration, branching, and subroutine invocation, etc. invoked on a set of cells. Some applications such as Lotus allow users to specify parameters to macro programs. However, such programs must be invoked manually or from within other macros as opposed to callable functions from within formulas of the spreadsheet language. This is just one of the instances which show that Macro programming language and model is essentially different than the spreadsheet language and model and requires programming expertise. Besides these commercial products, there is a large body of research related to the spreadsheet paradigm.

Yoder et al. [2] had made many extensions to the spreadsheet paradigm, including local variables in cells and cell formulas, iteration and branching, user-defined functions and cell names, dynamic creation and deletion of cells, and message-passing for inter-cell communication. They extend the spreadsheet paradigm allowing a block of cells to be associated with a function that takes parameters and returns a result. However it lacks to provide user-defined cell types and type checking. In fact Yoder et al. are unclear about cell types, and do not make a conclusive argument whether cell type structures should be block of cells, or a single cell with many properties (e.g., like an object). In fact when referring to cells like objects Yoder et al. admit that modeling inheritance could be problematic in this case. One major drawback of the approach Yoder et al. took is that code to accomplish a lot of the programming extensions such as iteration, branching, etc. are written in a separate programming language and model as standard cell functions for handling cell events. Users would extend for example handler( ) function and input code much as C programming language where cells can access any value.

Wack [3] explored the implicit parallelism of the spreadsheet paradigm and added several features such as user-controlled dimensionality, infinite definitions, separation of data-driven and demand-driven parts of the spreadsheet and user-defined functions by allowing cells to be lamda-forms.

Clack and Braine [4] proposed a spreadsheet paradigm, which incorporate a number of features from object-oriented paradigm and functional languages. Features inherited from functional languages include higher-order functions, a string type system, curried partial applications, referential transparency, and lazy evaluation. Features inherited from object-oriented paradigm include class hierarchy, inheritance, overloading, overriding, subsumption, and dynamic dispatch on objects.

Jones, Blackwell, and Burnett [5] described extensions to the commercially available Excel spreadsheet that integrate user-defined functions into the spreadsheet. In their approach users create function-instance sheets which provide the implementation of the function along with specifications of the input and output cells. To refer to such function users simply use the sheet name as the function name and pass the required number of parameters as input. To keep it consistent with the spreadsheet paradigm each function evaluation creates an instance of the function instance sheet with the input cells referring to the parameters of the function.

The notion of declarative functions as new sheets was first introduced in Forms by Burnett et al. [6], proposed Forms/3, a follow-up system of the original Forms work, incorporating procedural abstraction, data abstraction, and graphics output into the spreadsheet paradigm without deviating from the first-order declarative evaluation model. Programming in Forms/3 follows the spreadsheet paradigm, where the programmer uses direct manipulation to place cells on forms, and then defines a formula for each cell. Such a formula may include constants, references to other cells, or references to the cell's own value at a previous moment in time. Cells are referenced by clicking on them as Forms/3 utilizes a free form layout as opposed to the two-dimensional grid structure familiar in spreadsheets. While this provides some flexibility in terms of programming it in some ways is a deviation from the spreadsheet metaphor in that cell referencing by spatial location is eliminated. In addition to traditional spreadsheet cells, Forms/3 supports built-in complex graphical types and user-defined complex types. Type-related attributes are defined by formulas in groups of cells, and an instance of a type is the value of an ordinary cell that can be referenced just like any other cell. Forms contain at least one distinguished cell called an abstraction box which defines the structure of the type as the composition of its attributes. Note here that though complex types in Forms/3 are similar to objects there are significant differences, namely complex types only define the state, it does not define the behavior unlike objects.

NoPump and its successor NoPumpII [7] are two other research spreadsheet prototypes that are designed for interactive graphics. These provide support for creating built-in graphical types that can be instantiated using expressions as well as support for limited manipulating capabilities. There is no support for complex or user-defined objects.

Penguims [8] is another research spreadsheet project for user interface specification. Similar to Forms/3 it provides support for abstraction where cells can be collected together. Unlike Forms its language is imperative and code can be written to modify the formulas of other cells.

### SUMMARY OF THE INVENTION

This invention involves the development of an object-oriented model and event-based imperative language for spreadsheet programming. Spreadsheet programming model and language is extended to create objects, with their associated state and set of defined behaviors, as first-class spreadsheet cell residents. Desired object behaviors can be invoked by calling methods on the objects through a programming language that potentially modifies the state of an object. Expressions can also be defined by calling methods on objects that produce new objects in combination with operations on objects in other cells.

Programming constructs are defined that allows users to perform a sequence of operations on one or more objects. Operations can also be performed automatically similar to spreadsheet triggering mechanism. Users can program to trigger operations either manually or automatically based on changes to objects, or based on conditions defined.

More specifically, one embodiment of the invention is an electronic spreadsheet having at least one grid of cells that allows users to place predefined programming code statements within the cells. The programming code statements are adapted to be sequentially applied. Thus, the programming code statements comprise statements that assign an object to a cell, comprise conditional statements, user-defined statements, and/or multiple blocks of programming code statements.

In another embodiment, the programming code statements comprise conditional statements utilizing “on” and “when” constructs. Thus, the conditional statements can comprise boolean expression conditions, object assignments changes, and/or object property changes. The conditional statements can be made conditional on user interaction, spreadsheet events, a user and/or defined ordering of events. The conditional statements can be explicitly triggered (by calling object methods that change the object state or properties) or implicitly triggered (through functional dependencies). Also, in a related embodiment, the programming code statements can be triggered to perform a certain number of iterations of a certain processing step. Also, the programming code statements can comprise instructions to copy and distribute objects to different cells. In other embodiments, the programming code statements comprise conditional pause statements, and/or statements adapted to either insert or modify programming code statement in other cells. For example, programming code statements can comprise statements that assign a collection of objects to a cell, statements that execute a method on an object in another cell, statements that execute a method on an object in another cell with parameters from objects in other cells in the grid, statements that execute a function on an object in another cell and assign the resultant object into the cell, and statements that execute a method on a collection of objects in other cells.

Additionally, the interactor components provide rendering and interaction capabilities for command-line interfaces, graphical user interfaces, and form-based web interfaces. This method also shows the layout and the size of the interactor components can be modified by the user to define the look of the application developed.

This invention brings to spreadsheets many of the advantages that object-oriented programming has brought to programming languages and databases. Through an object-oriented approach spreadsheet users may achieve greater computational capability and expressive power at the same time reduce complexity and improve productivity by means of reusable higher-level objects than the basic data types without behaviors as in current spreadsheets. Object-oriented approaches yield power, elegance, maintainability, extensibility, and usability in programming for high-level solutions.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

The invention will be better understood from the following detailed description with reference to the drawings, in which:

FIG. 1 is a schematic diagram of a screen shot of spreadsheet;

FIG. 2 is a schematic diagram of a screen shot of spreadsheet;

FIG. 3 is a schematic diagram of a screen shot of spreadsheet;

FIG. 4 is a schematic diagram of a screen shot of spreadsheet;

FIG. 5 is a schematic diagram of a screen shot of spreadsheet;

FIG. 6 is a schematic diagram of a screen shot of spreadsheet;

FIG. 7 is a schematic diagram of a screen shot of spreadsheet;

FIG. 8 is a schematic diagram of a screen shot of spreadsheet;

FIG. 9 is a schematic diagram of a screen shot of spreadsheet;

FIG. 10 is a schematic diagram of a screen shot of spreadsheet;

FIG. 11 is a schematic diagram of a screen shot of spreadsheet;

FIG. 12 is a schematic diagram of a screen shot of spreadsheet;

FIG. 13 is a schematic diagram of a screen shot of spreadsheet;

FIG. 14 is a schematic diagram of a screen shot of spreadsheet;

FIG. 15 is a diagram of the user interface;

FIG. 16 is a diagram of the user interface showing objects, expressions, commands;

FIG. 17 is a diagram of the engine;

FIG. 18 is a diagram of the cell reference and cell behaviors;

FIG. 19 is a diagram showing linked behaviors in cell expressions;

FIG. 20 is a diagram showing object functions and operations;

FIG. 21 is a diagram showing object functions and operations;

FIG. 22 is a diagram showing object functions and operations;

FIG. 23 is a diagram showing API process configuration;

FIG. 24 a diagram showing System A and System B computer systems;

FIG. 25 a diagram showing System A and System B computer systems;

FIG. 26 a diagram showing user interface showing objects, expressions, commands;

FIG. 27 is a diagram showing an HTTP connection monitoring tool; and

FIG. 28 is a diagram showing tools to include application server connections.

### DETAILED DESCRIPTION OF PREFERRED EMBODIMENTS OF THE INVENTION

The present invention and the various features and advantageous details thereof are explained more fully with reference to the nonlimiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention. The examples used herein are intended merely to facilitate an understanding of ways in which the invention may be practiced and to further enable those of skill in the art to practice the invention. Accordingly, the examples should not be construed as limiting the scope of the invention.

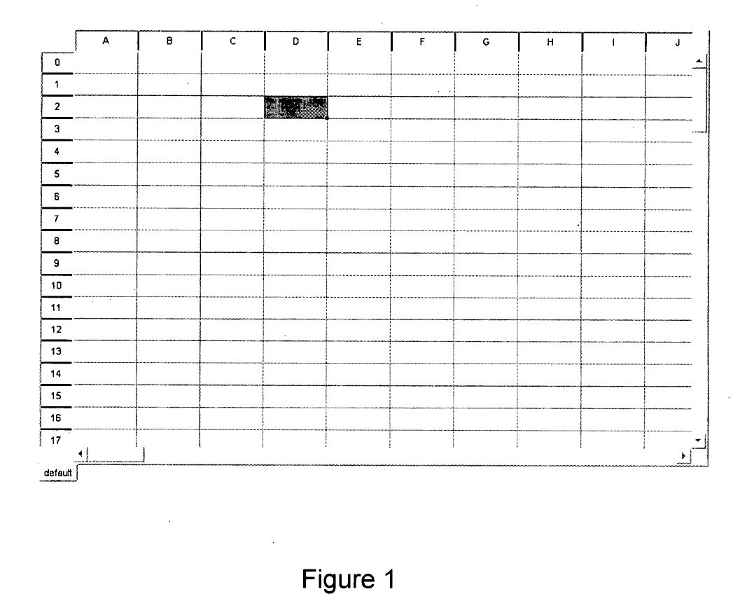

Users interact with the invention pretty much in the same way they interact with other spreadsheet programs. Users are by default presented with an empty spreadsheet composed of cells, as shown in FIG. 1.

Each cell essentially contains objects, expressions, or commands. Users interact with cells by first selecting a cell or group of cells by highlighting them. To highlight a cell, simply click on a cell box. To highlight a group of cells click on a cell and drag to contain all the desired cells in the group.

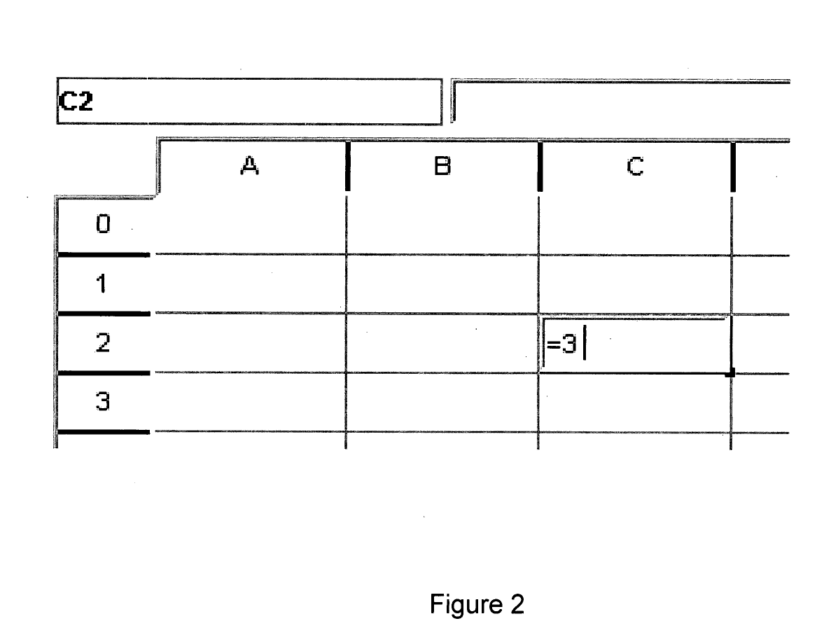

To enter objects, expression, or commands one will need to edit a cell to enter code. To edit a cell one will first need to select a cell by clicking on the cell box. Then, one will need to click again to enter code, for creating objects, defining expressions, or commands for that cell, and begin to write code, as shown in FIG. 2.

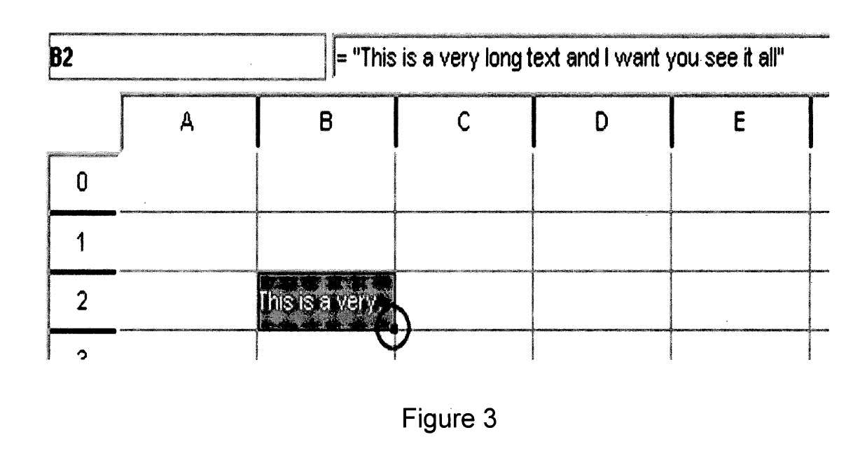

To finish editing one will need to hit ENTER. To delete a cell simply hit the DEL key after selecting cells. When working with sheets one will often find oneself copying and pasting cell contents, to replicate data, expressions, and commands. Copy and paste are easy to use functions that can improve ones efficiency significantly. To copy a cell or group of cells one will first need to select the cell or group of cells. Then, click on the COPY button. To paste likewise select the destination cell or group of cells and click on the PASTE button. Sometimes, one may find the cell box area insufficiently small to display cell contents, especially for some visualization components. One option is to increase the cell box size by expanding the cell over other cells to occupy a larger cell area. To expand a cell one will first need to select the cell. Selecting the cell will highlight the cell area as well as create a red expansion box around the borders of the cell. One can use the expansion box to make the cell area larger by selecting the lower-right corner of the box and dragging it over to occupy nearby cell areas, as shown in FIG. 3.

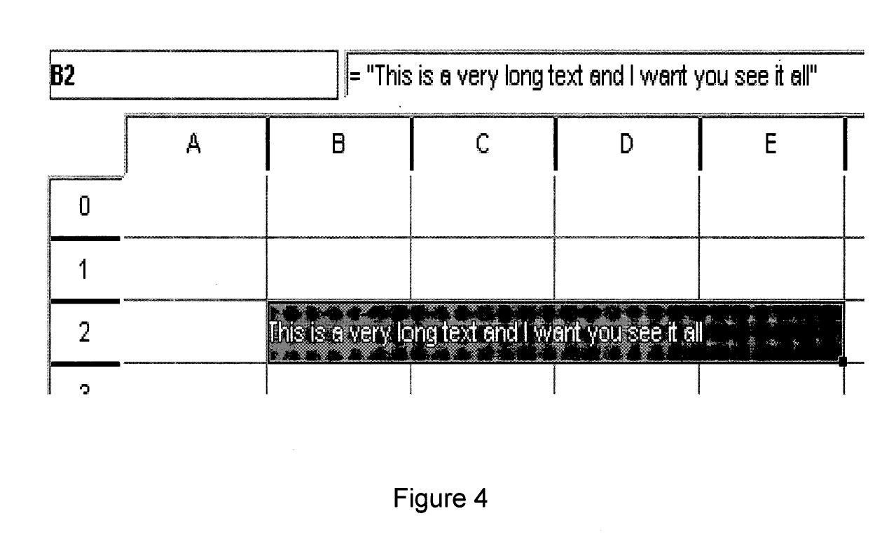

Alternatively, one can choose to enlarge either a column or a row of cells. This would be particularly useful if all cells in a particular column contain similar components that one would want to see larger. To change the column width, for example, one will need to click on the right border of the column in the column header and drag to make it larger, as shown in FIG. 4.

As mentioned earlier in the invention, cells can contain objects, expressions, and commands. While objects can be as simple as numbers and text, as in most spreadsheets, in the invention, they can also be graphical user interface components such as buttons and checkboxes, and visualization components such as plots and pie charts, that allow users to interact with them.

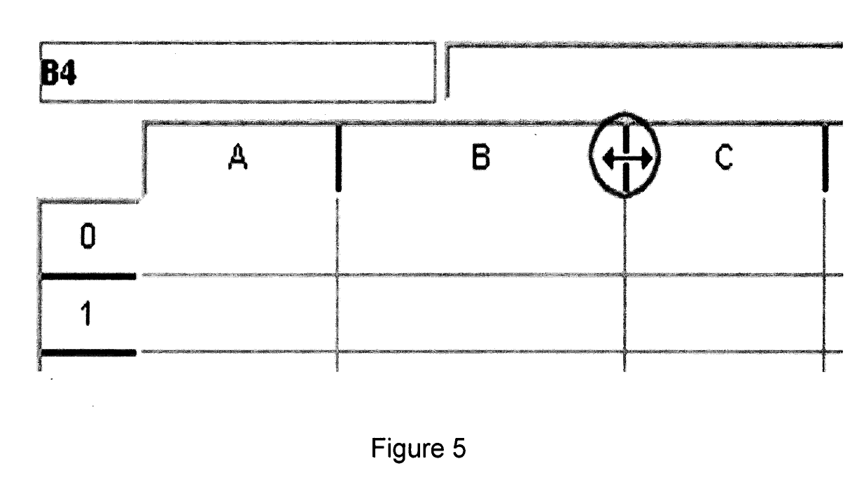

Once created, users simply interact with these objects as they would do in any application. For example, they could click on buttons to initiate an action, or select a checkbox, etc., as shown in FIG. 5.

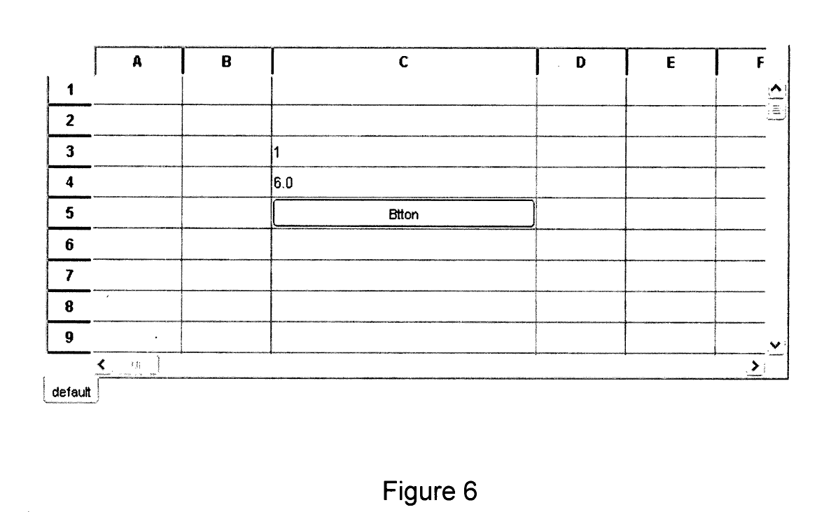

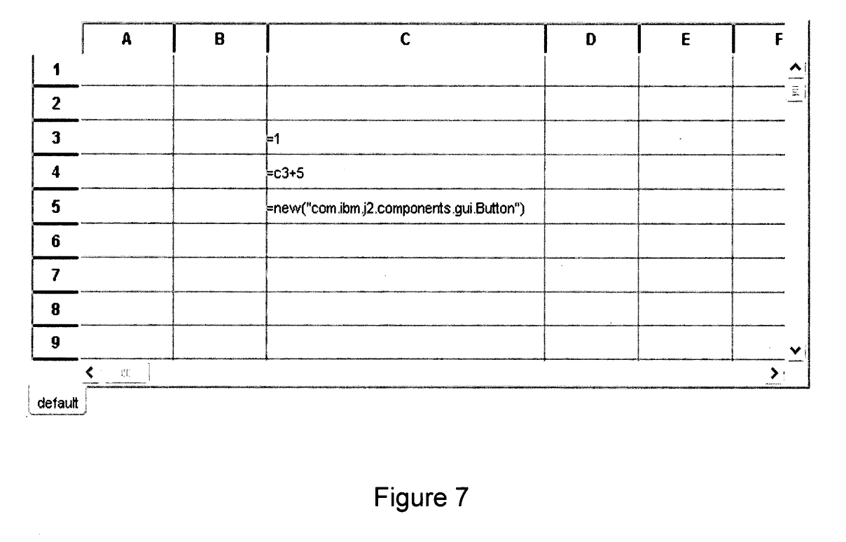

By default, the invention displays cell values on each cell box. As one works on ones code one may sometimes find it necessary to view the cell codes or cell component types. To view cell code or component types one can simply select the View/Code or View/Type functions from the Menu Bar. For example, to switch to the code view from the default value view below, simply select View/Code from the menu, as shown in FIG. 6 and FIG. 7.

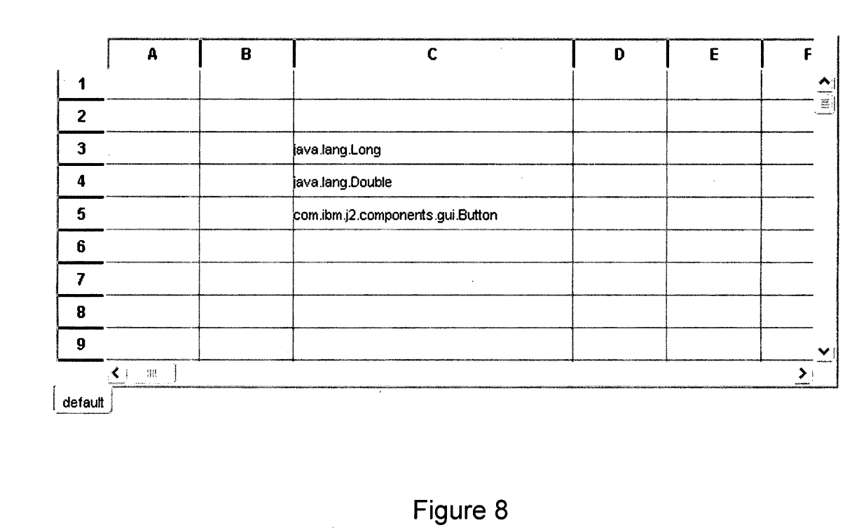

The component type view of the above example is shown in FIG. 8. The inventive interface also allows users to create new spreadsheets, rename, or delete existing sheets. Collection of sheets can be saved and later loaded.

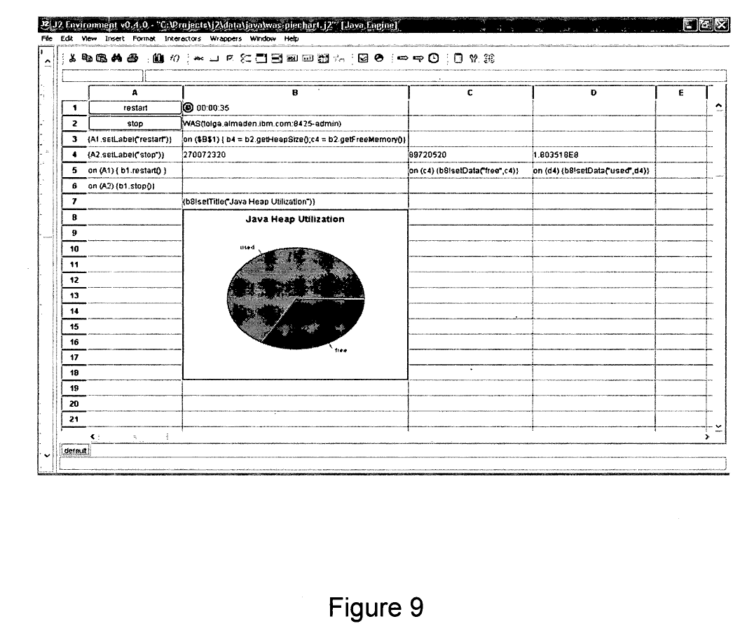

Once tools are developed they can be exported to a portal server to run in a web runtime environment. Users can simply select Export/As Web Application to accomplish this. When exported the tool looks pretty much similar to the tool under development in the invention GUI, as shown in FIG. 9. The few differences are that cell code and grid lines of the sheet are not visible.

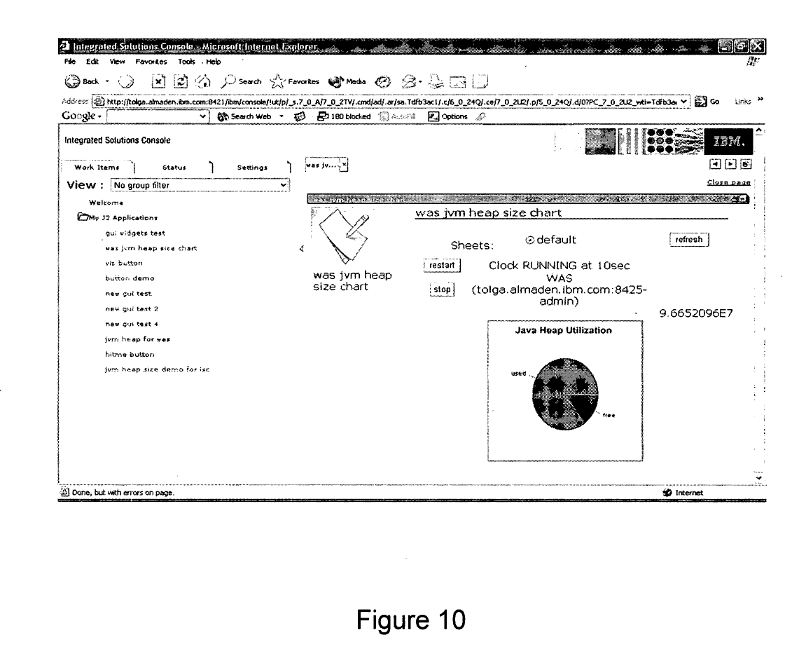

FIG. 10 shows the Tool under development in the invention GUI. Once the tool is exported all system administrators that have access to the portal web pages can access and use the tool if they have the right credential to do so. If they have the rights they can also edit the tool by clicking on the EDIT button on the portal page which launches the invention GUI with the code loaded. Users can then modify the code for the tool and simply save it back. Next time they access the tool over the portal pages they can work with the updated tool.

FIG. 10 shows the tool when exported to Portal. The invention extends the popular spreadsheet paradigm to provide more programming capabilities for small-scale tool development. Such capabilities mostly derive from the object-based approach taken in the invention programming language that fits nicely in to the spreadsheet model.

In the invention, cells contain objects, expressions, and commands. Objects can either be created by the user or assigned to cells as a result of evaluating expressions that define the functional relationship between objects in various cells. In the invention, some cells can contain code consisting of various programming constructs to perform operations on objects.

In the invention, one can perform mathematical operations, such as addition, subtraction, multiplication, and division, by defining expressions in cells. These expressions essentially define the functional relationship between cells referenced, in very much the same way in most spreadsheets.

To enter a number, one will simply need to write in the number into a cell, e.g.,

$$A 1 : 1$$

To enter an expression, one will need to precede the expression with an equals sign, e.g., =A1+A2. Essentially, this means that the cell containing the expression has the value that corresponds to the result of performing the operations defined in the expression. For example, to add cell A1, with a value of 1, and A2, with a value of 2, in cell A3, one will need to edit A3 and write in the expression=A1+A2, as shown below:

$$A 1 : 1 , A 2 : = 2 , A 3 : = A 1 + A 2$$

Once the expressions are entered one will see the operations in the expression are immediately performed and the resultant value is put into the cell. In the above example, the resultant 3 is put into cell A3.

Note that once an expression is defined it always remains active. As the cell data that the expression depends on change, the expression will be automatically reevaluated to reflect changes in data. In the above example, if A1 is changed to 3, expression in A3 will be triggered since its expression (=A1+A2) depends on A1 by definition. As a result, the expression will be reevaluated to reflect the change in A1, and A3 will be assigned the value 5 (3+2).
Textual data is handled much the same way as numeric data. To enter text, one will need to edit the cell and write the text in quotes, e.g., “world”. For example, to put the text “J2” in cell A1:

$$A 1 : '' J 2 ''$$

Like mathematical operations, there are a number of operations defined on textual data. The following is an example to concatenate two cells that contain textual data in another cell, as shown below:

$$A 1 : = '' brother '' , A 2 : = '' sister '' , A 3 : = A 1 + A 2$$

As a result the value of A3 will be “brothersister.” Here in this example, the symbol+in the expression defines the concatenation operation.

When one is working with multiple spreadsheets it may be necessary to refer to the cells in other sheets. As shown in the previous examples, the invention refers to cells by their row and column indices, e.g., A4. When working with multiple sheets it will be necessary to identify which sheet one is referring to specifically in addition to the cell row and column. To refer to a cell in another sheet one needs to specify cell the sheet name as a prefix to the cell address, separated by a pound sign (#). For example, to refer to cell C6 in sheet MySheet, one needs to use MySheet#C6.

With the invention, one can refer to cells in a three different ways: absolute, relative, and mixed. These different cell addressing conventions only matter when one performs copy and paste, and follows the conventions of most spreadsheets. For example, with relative cell addressing, when one copies code from one area of the worksheet to another, the invention updates the code in the destination according to the position of the cell relative to the cell that originally contained the code.

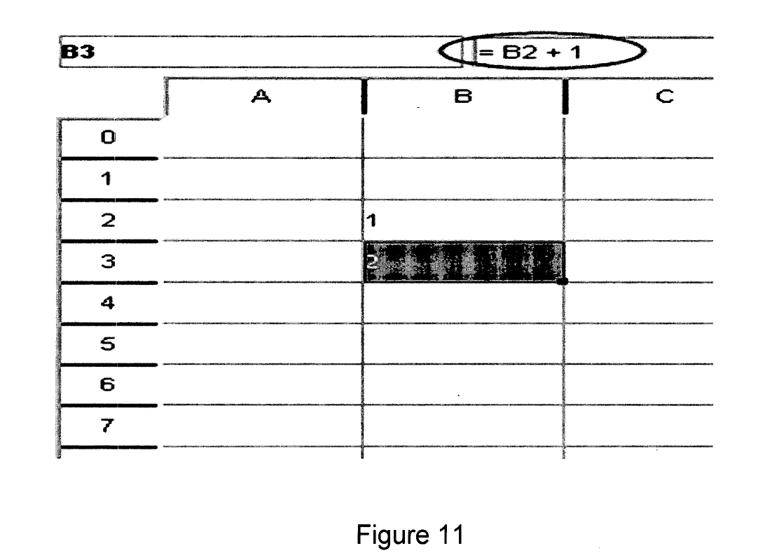

This is shown through the following example. Assume that cell B2 contains the number 1, and cell B3 has the expression=B2+1, thus the data in cell B3 is an increment of the data in B2. To do this iteratively for cells B4 through B7, all one need to do is to copy cell B3 and paste over cells B4 through B7. As one pastes cells one will see that expressions are rewritten to reflect the relative location of the cells. For example, in this case, cell expression in B4 will be B3+1, as shown in FIG. 11.

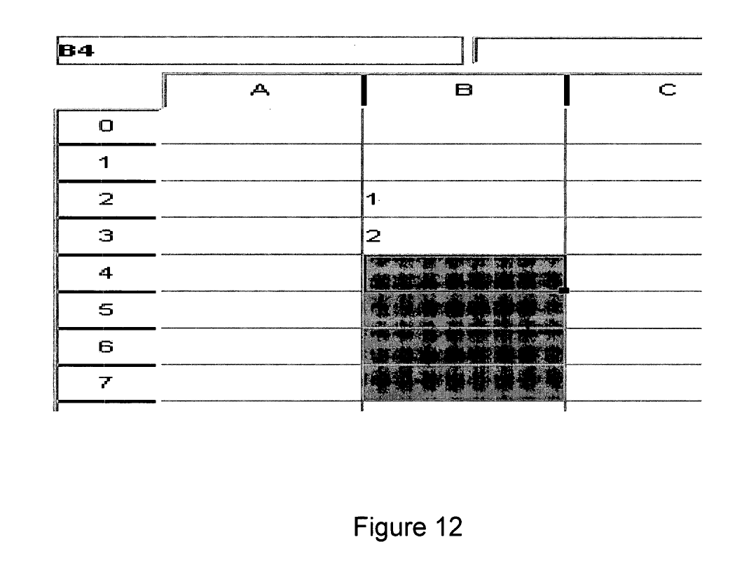

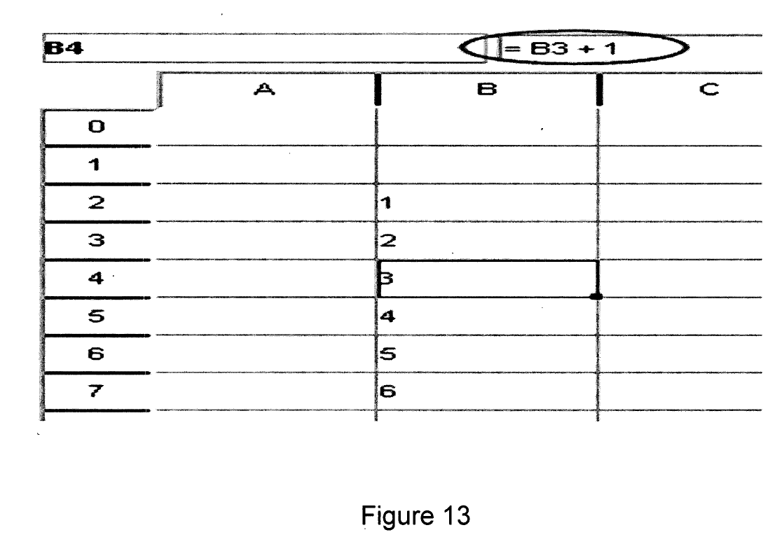

To prevent relative addressing during expression rewrite one may want to use an absolute cell address, where both the column and row identifiers in the cell address are prefixed with the dollar sign ($). In the above example, if the expression for B3 was =$B$2+1 instead, when copied over B4 through B7, all will have the same expression (=$B$2+1) thus will have the value 2 as shown in FIG. 12 and FIG. 13.

In the invention, one can create objects such as graphical user interface, visualization, programming, and system components, and work with them just like numeric and textual data.

To create objects one will need to use the new( ) function and provide an object type identifier as a parameter. For example, a Clock object can be created in cell C3 by editing the cell and writing in the code, new(“com.ibm.J2.components.prog.Clock”), where com.ibm.J2.components.prog.Clock is the object type identifier. Alternatively, the object type identifier can also be used to create an object, e.g. com.ibm.J2.components.prog.Clock( ), or in short form simply as Clock( ). Some objects may need optional parameters that can be passed as parameters to the object operation. For example, for the Clock object one can optionally provide the period at which the clock will fire events, e.g., new(“com.ibm.J2.components.prog.Clock”, 5) for a 5 sec period.

Using Object Functions in Expressions

With the invention, components come with a set of functions that provide information on component state and properties. Expressions can contain such functions, where they are specified as the cell address that contains the component followed by a dot (.), and the function name with open (( ) and close ( )) parentheses. If the function requires parameters one can also specify them separated with commas (,) in the parentheses following the function name.

For example, to get the delay period of a Clock component in cell C3, one can write=C3.getDelay( ) as an expression for cell C4, where getDelay( ) is the function that returns the delay period of the Clock. Component functions can also be used mixed with other type of functions, such as mathematical functions. For example, =C3.getDelay( )*5+10 is a valid expression in the inventive spreadsheet.

Using Object Operations in Code

One feature of the invention is that it goes beyond using mere object functions and expressions (which only perform functional programming) by allowing the use of object functions in code statements (thereby permitting “imperative” programming, as opposed to typical “functional” programming). Broadly speaking, in imperative (or procedural) programming languages, programmers define computation by explicitly specifying the proper flow of commands that alter the state of a program for processing data. In contrast, in functional (or declarative) programming languages, programmers define computation by defining the functional relationships between data and execution is performed implicitly based on input and output of data More specifically, by allowing imperative programming, the invention breaks new ground by including statements that can be sequentially applied, conditionally triggered using “on” and “when” constructs, allowing statement execution to be conditionally applied, as well as permitting statements that can insert or modify cell expressions and other code statements.

Most components also have a set of operations to set component properties, or to perform actions on the components changing the state of the component, etc. With the invention, code to perform operations can be written by first opening a curly bracket ({), then specifying the cell address that contains the component followed by an exclamation point (!) and the operation name with open (() and close ()) parentheses, and finally closing the curly bracket (}). If the operation requires parameters one can also specify them separated with commas (,) in the parentheses that follow the operation name. Note that these operations do not have a preceding equals sign (=), different from expressions, as typically there is no resultant value that is assigned to the cell.

When these operations are performed on components it causes the component state (or properties) to change, thus triggering other cells that depend on this cell to reevaluate their expressions. For example, one can set the period for a Clock component in cell C3 by writing the command code {C3!setDelay(4)} in cell C4:

$$C 4 : \{ C 3 ! setDelay ( 4 ) \}$$

This operation will change the delay period of the Clock and will trigger cells which has an expression dependent on C3 to reevaluate. For example, cell C5 with the expression=C3.getDelay( ) will be reevaluated and assigned to the new value 4.

$$C5 : = C 3. getDelay ( )$$

Cells that contain code are different from expressions also in the way that they do not automatically reexecute the same way expressions reevaluate. Expressions are reevaluated when there is a functional dependency by definition of the functional relationship. Code however does not have such a dependency. Continuing with the previous example, resetting the Clock in cell C3 below would cause the expression in C5 to be reevaluated however code in C4 will not be reexecuted:

$$C 6 : \{ C 3 ! reset ( ) \}$$

One can also write code to perform operations on a set, or range of cells in a single statement. This is particularly convenient when there are a number of components. Such commands can be written with comma (,) separated list of cell addresses, or ranges of cells in parenthesis, followed by the exclamation sign (!), operation name, and comma (,) separated list of parameters, if applicable. For example, to set the delay period for Clock components in cells C3, C5, and cells B2 through B7 to 10 seconds, one would write the code {(C3, C5, B2..B7)!setDelay(10)}. Note that cell ranges are separated with the (..) sign.

Code Blocks

When writing code one may need to perform a number of operations in sequence. Therefore, the inventive spreadsheets provide a specific mechanism by which the programming code statements can be sequentially applied. To order operations, one option one has is to explicitly code the sequence in a code block in one cell. Thus, with the invention, an individual cell can include multiple programming code statements separated by the controllers such as a semicolon or other character. To do this one will need to separate each statement by a semicolon (;). For example, in the below code, the numbers 10 and 5 are added to the ObjectCollection in A1 in that order. Thus, the A1 would have the value [10,5] and A3 would be 2, as a results of running the operations in A2:

$$A 1 : new ( '' ObjectCollection '' )$$

$$A 2 : \{ A 1 ! add ( 10 ) ; A 1 ! add ( 5 ) \}$$

$$A 3 := A 1. size ( )$$

Code blocks are executed at the time they are inserted into the sheet. Unlike expressions they are not automatically reexecuted but one can explicitly reexecute command blocks by calling them in code elsewhere. For example, to reexecute statements in code block in A2, all one need to do is call A2 as part of another code block. For example, cell A4 might have a code block such as { . . . ; A20; . . . ;}

Assignment Statement

With the invention, the programming code statements can assign an object to a cell. Assignment statements can only exist inside command blocks and allow one to change the value of another cell directly inside the code of another cell. For example,

$$A 1 : = 1 , A 2 : = A 1 + 1 , A 3 : \{ A 1 = 3 \}$$

Executing these code will change the value of A1 to be set to 3 and indirectly A2 will be changed to 4.

If Statement

Further, the programming code statements can comprise conditional statements. An if( ) statement likewise only exist inside a code block and allows one to perform different operations based on the value of a condition. For example, in the code below:

$$A 1 : = false$$

$$A 2 : new ( '' ObjectCollection '' )$$

$$A 3 := \{ if ( A 1 ) \{ A 2 ! add ( 10 ) \} else \{ A 2 ! add ( 5 ) \} \}$$

When A3 is executed the value of A1 is checked to see if it evaluates to true or false. If it evaluates to true 10 will be added to the ObjectCollection in A2 otherwise 5 will be added. In the above case since A1 is false, 5 will be added to A2.

Return Statement

A return statement also exists only as part of a code block and allows one to exit execution at a desired point. Typically, a return statement is used in conjunction with an if( ) statement and allows one to stop executing remaining operations inside a code block when certain conditions are met.
For example,

$$A 1 \text{:} = true$$

$$A 2 \text{:} new ( '' ObjectCollection '' )$$

$$A 3 \text{:} \{ if ( A 1 ) \{ A 2 ! add ( 10 ) ; return ; \} A 2 ! add ( 5 ) ; \}$$

Since A1 is true the above code will add 10 to the ObjectCollection in A2 and will return before executing the last add( ) operation on A2.

Listener Code Blocks

In one embodiment, the programming code statements comprise conditional statements that utilize, for example, “on” and “when” constructs. These constructs can include any boolean expression, such as the ones discussed below. Further, as shown below, these constructs can look for cell occurrences where object assignments change and/or object state or properties change. Further, the constructs can look for specific user interaction, such as a certain input. In addition, the constructs can comprise spreadsheet events, such as loading, refreshing, recalculating, etc. Further, the constructs can look for and be made conditional upon a user defined ordering of events (such as A1 followed by A2 or A3).

While code blocks do not automatically get reexecuted, sometimes one may want to explicitly set such code blocks to automatically trigger reexecution upon changes to data in other cells. Such a code block is called a listening code block where the triggering cells are explicitly specified in an on( ) construct.
For example,

$$A 1 \text{:} new ( '' Button '' )$$

$$A 2 \text{:} = 0$$

$$A 3 \text{:} on ( A 1 ) \{ A 2 = A 2 + 1 \}$$

Where A1 is a Button component and A2 is a number initialized to 0. Cell A3 contains a listening command block that listens to changes on cell A1 and executes the increment command each time the Button in A1 is pressed.

Multiple cells can be specified in an on( ) construct so that each triggers the listening code block. These cells can be specified either as comma (,) separated parameters, or as cell ranges, e.g., on(A1,A4,B1..B4) {A2=A2+1}. In this example, changes to cells A1, A4, and B1 through B4 can trigger the increment command in the on( ) construct. In some cases it may be important to know which cell actually triggered the execution. In fact that cell can be referred to as source in the statements inside the code block. For example, on (A1,A4,B1..B4) {A2=A2+source}, A2 will be increment by the object that triggers the code block.

Conditional Code Blocks

Conditional code blocks execute when the specified condition evaluates to true. Conditions are explicitly specified inside a when( ) construct.
For example,

$$A 1 \text{:} = false$$

$$A 2 \text{:} new ( '' ObjectCollection '' )$$

$$A 3 \text{:} when ( A 1 ) \{ A 2 ! add ( 10 ) \} else \{ A 2 ! add ( 5 ) \}$$

In the above example, initially the ObjectCollection in cell A2 will be empty. Later, when A1 is changed to true, A3 will be triggered and 10 will be added to the ObjectCollection in A2. If later A1 is changed to back false 5 will be added to A2. When( ) construct is in fact similar to an on( ) construct where any change triggers the command reexecution. In a when( ) construct however the condition needs to evaluate to true.

The conditional part of a when( ) construct can be quite complex, including inequalities, e.g., A1>A3, logical operations, e.g., A1& A3, and other combinations.

Cell Names

When one is working with expressions or commands, one may sometimes find it difficult to remember the cell addresses and what they are corresponding to in one's tool. One may find it more convenient to assign meaningful names to cells.

In the invention, one can give names to a cell or group of cells by simply specifying the cell name, followed by colon (:) followed by the code of the cell. For example, if the cell A3 contains the salary of an employee, and cell A4 contains the bonus, one might prefer to refer to the cells as salary, and bonus, respectively, as shown below:

$$A 3 \text{:} salary \text{:} = 97000 , \\ A 4 \text{:} bonus \text{:} = 7000$$

Once a cell is given a name one can use that name instead of the cell address when one is referring to that cell in ones code. For example, to calculate the total compensation for the employee in cell A5 one can write the expression as the following:

$$A 5 \text{:} = salary + bonus$$

In fact one can also name cell A5 as compensation, as shown below:

$$A 5 \text{:} compensation \text{:} salary + bonus$$

Cell names can also refer to a range of cells, for example:

$$A 1 \text{:} '' mom ''$$

$$A 2 \text{:} '' dad ''$$

$$A 3 \text{:} '' brother ''$$

$$A 4 \text{:} '' sister ''$$

$$B 1 \text{:} family \text{:} ( A 1 … A 4 )$$

$$C 1 \text{:} = family ( 0 )$$

In this case to refer to a specific cell in the range one will need to use the cell name with the index of the cell as a parameter, e.g., family(0) to refer to A1 in the above example.

Cell names can also be assigned to code blocks, for example:

$$A 3 \text{:} salary \text{:} = 97000 , \\ A 4 \text{:} raise \text{:} = 7000$$

$$A 5 \text{:} giveRaise \text{:} \{ salary = salary + raise ; \}$$

$$A 6 \text{:} \{ if ( salary < 100000 ) \{ giveRaise ( ) ; \} \}$$

User-Defined Operations

With respect to the programming code statements comprising user-defined statements, the preceding example is actually a first step in the direction of user-defined operations. In that example, users can give names to cells containing code and use that name in code elsewhere to execute it. The next step is essentially to be able to pass parameters to the code. In the invention, expressions or code can contain cell references which can later be substituted for actual cells. Such cell references are in the form of a dollar ($) sign followed by a number to indicate the index of the parameter, e.g., $0, $1. Thus, for example users can write

$$C 5 \text{:} add \text{:} = \$0 + \$1$$

$$C6 \text{:} = add ( 3 , A 1 )$$

to add two numbers passed as parameters. Substitutions can likewise be made in code blocks as well. For example,

$$C 5 \text{:} i nitialize \text{:} \{ \$0 . init ( \$1 ) \}$$

$$C6 \text{:} \{ initialize ( 3 , A 1 ) ; \}$$

Touch Statement

Also, the conditional constructs can be explicitly triggered statements that operate upon the occurrence of explicit events. To the contrary, the conditional constructs can also be implicitly triggered statements, such as being triggered by calling object functions. Triggering can be done explicitly through the touch( ) statement. Touch( ) statement essentially does not change the cell value but it simulates a change in that cells where dependent expressions will reevaluate, and listening or conditional code blocks will reexecute.
For example,

$$A 1 \text{:} = 0$$

$$A 2 \text{:} = 0$$

$$A 3 \text{:} on ( A 1 ) \{ A 2 = A 2 + 1 ; \}$$

$$A 4 \text{:} = A 1 + 4$$

$$A 5 \text{:} \{ touch ( A 1 ) \}$$

executing A5 will trigger both A3 which is listening to changes in A1 and A4 which has an expression dependent on A1. As a result the value of A2 will be incremented by 1 and A4 will be reevaluated to still 4 since the value of A1 did not change as a result of the touch( ) statement.
Wait Operation

Once multiple cells are triggered they can execute in any arbitrary order. In the invention, one can make sure of the ordering of operations through sequencing operations in a code segment, as shown earlier. Sometimes, one may have to split the code into multiple cells and thus need another mechanism to synchronize the execution. Therefore, the invention provides programming code statements that comprise conditional statements. This wait( ) operation allows one to do just that. With the wait( ) operation one specifies a condition which blocks the execution of the operations in that cell until the condition is satisfied. When satisfied, the execution continues from the point it left. Users can specify the conditions such that it will order the execution of operations in multiple cells. Look at an example.

$$A 1 \text{:} new ( '' ObjectCollection '' )$$

$$A 2 \text{:} new ( '' Button '' )$$

$$A 3 \text{:} = false$$

$$A 4 \text{:} on ( A 2 ) \{ A 1 ! add ( 10 ) ; A 3 = true ; \}$$

$$A 5 \text{:} on ( A 2 ) \{ wait ( A 3 ) ; A 1 ! add ( 5 ) ; A 3 = false ; \}$$

In this example there are two cells, A4 and A5, both listen to the button events. A5 however contains a wait( ) operation which basically blocks execution until A3 becomes true. A3 on the other hand is initially set to false, and becomes true when A4 is executed. Coding the wait( ) operation in A5 essentially makes sure that code in A4 is run before code in A5 is executed.

In the above example the wait condition is very simple, essentially a single condition. One ordinarily skilled in the art world would understand that more sophisticated conditions can be set that order multiple cells and executes them in different conditions.

Copy, Distribute, and Iterate Operations

When working with spreadsheets one will find copy and paste operations to be useful in saving one significant time especially to replicate data, expressions, and operations on a number of cells. Copy and paste operations accessible from the invention Interface will work just fine when one know the number of cells one would like to replicate onto. However, when programming tools, quite frequently one will need to apply the same expression or operations on an unknown number of cells.

Thus, the invention provides the copy operation as a programming construct as well. Also, in a related embodiment, the programming code statements can be triggered to perform a certain number of iterations of a certain processing step. Thus, the programming code statements can comprise instructions to copy and distribute objects to different cells.

Through the use of copy( ) operation one can essentially create an always active copy/paste functionality. Thus, as new elements are added or changed in the source range they will be automatically pasted over the destination range, just like the manual copy and paste would work from the invention interface. For example,

$$B 1 \text{:} on ( A 1 ) \{ copy ( A 1 , A 5 ) ; \}$$

In the above case, cell A1 is copied over cell A5. Whenever the expression or operations defined in A1 are changed it will be copied over to cell A5. Note that the copy( ) operation copies the expression or code not the values of the cells. Thus, the expression or code rewrite will be performed. For instance, in the above example, if A1 has the expression A2*5+$A$3, the copy operation defined in B1 would rewrite the expression in cell A5 as A6*5+$A$3, where the absolute and relative cell addresses are taken into account during the expression rewrite.

copy( ) operation can also be defined over a range of cells, as shown in the below example:

$$A 1 \text{:} = B 1 + \$ F \$1$$

$$A 2 \text{:} = A 1 + \$ F \$1$$

$$A 3 \text{:} = A 2 + \$ F \$1$$

$$B 2 \text{:} on ( A 1 … A 3 ) \{ copy ( A 1 … A 3 , C 1 … E 3 ) ; \}$$

In this case, cells A1 through A3 will be copied over cells C1 through E3. As a result, cells C1 through E3 will be assigned the following expressions:

$$C 1 \text{:} = D 1 + \$ F \$1 , D 1 \text{:} = E 1 + \$ F \$1 , E 1 \text{:} = F 1 + \$ F \$1$$

$$C 2 \text{:} = C 1 + \$ F \$1 , D 2 \text{:} = D 1 + \$ F \$1 , E 2 \text{:} = E 1 + \$ F \$1$$

$$C 3 \text{:} = C 2 + \$ F \$1 , D 3 \text{:} = D 2 + \$ F \$1 , E 3 \text{:} = E 2 + \$ F \$1$$

If at any time later, A1 is changed to, say=B1*2+C1, C1 through E1 will be changed to:

$$C 1 \text{:} = D 1 * 2 + E 1 , D 1 \text{:} E 1 * 2 + F 1 , E 1 \text{:} = F 1 * 2 + G 1$$

Large numbers of objects can also reside in components such as ObjectCollection, which essentially holds all data in indexed data structures for access. Having a single cell for collecting a number of objects may be more convenient for some purposes but at times one may want to be able to distribute the contents of such component onto a range of cells. For example,

$$A 1 \text{:} new ( '' ObjectCollection '' )$$

$$A 2 \text{:} \{ A 1 ! add ( 1 ) ; A 1 ! add ( 2 ) ; A 1 ! add ( 3 ) ; \}$$

$$A 3 \text{:} on ( A 1 ) \{ dist ( A 1 , B 1 … B 100 ) ; \}$$

$$A 4 \text{:} \{ A 1 ! add ( 4 ) \}$$

In the above example, A1 contains a ObjectCollection component. As a result of executing A2, numbers 1, 2, and 3 will be added to in A1. The dist( ) operation in A3 essentially works like a set of assignment operations where the contents of the ObjectCollection is distributed over the cell range B1 through B100. In this example, B1, B2, and B3 are assigned to 1, 2, and 3, respectively. Note that this is not a one-time assignment but rather an active distribute operation. As the contents of the ObjectCollection change, it is distributed over the destination range defined in the dist( ) operation. Likewise, as new data is added to the ObjectCollection, such as in A4, new data will be distributed over the range defined. In the above case, B4 will be assigned to 4. Note the range defined in the above example is a fixed one, 100 cells in the B column, B1 through B100. One can however specific a whole column as the range, such as dist (A1, column(B)), in this case, the destination range is of arbitrary length, starting from B0. Alternatively, one can specify a starting point for destination using variants of distribute e.g., dist_across(A1, B8), dist_down(A1, B8).

To work with a large number of data one does not however need to distribute it over a range of cells all the time. One may prefer to iterate over the data and perform an operation. The Iterator component does exactly that using the start( ), stop( ), next( ), and getCurrent( ) operations.

In the following example, A1 is an ObjectCollection to which numbers have been added in A2. In A3, the inventions create an Iterator over the ObjectCollection in A1, and A4 holds the current object of the Iterator. A5 and A6 are initialized to false and 0. The code if A8 essentially triggers when A5 is set to true and starts iteration in A3. A4 is updated and each time it adds the current number in A4 to A6 and triggers to move the Iterator to the next number.

Thus, as a result at the end of the iteration A6 contains the sum of the numbers in A1.

$$A 1 \text{:} new ( '' ObjectCollection '' )$$

$$A 2 \text{:} \{ A 1 ! add ( 1 ) ; A 1 ! add ( 2 ) ; A 1 ! add ( 3 ) \}$$

$$A 3 \text{:} new ( '' Iterator '' , A 1 )$$

$$A 4 \text{:} = A 3. getCurrent ( )$$

$$A 5 \text{:} = false , A 6 \text{:} = 0$$

$$A 7 \text{:} on ( A 4 ) \{ A 6 = A 6 + A 4 ; A 3 ! next ( ) \}$$

$$A 8 \text{:} on ( A 5 ) \{ A 3 ! start ( ) \}$$

SpreadSheet Operations

In the invention, a number of operations are also available which allows users to programmatically refer to cells, rows, and columns, and sheets through operations such as cell(i,j),cellrange(cell(I,j),cell(k,l)),currentCell.getRow( ),currentCell.getColumn( ),currentSheet,column(j),row(i),row(i,start),column(j,start), and sheet(“name”). A number of cell and sheet operations are also available for use in code blocks, such as currentSheet.set(A1,“=5”),currentSheet.clear(A1..A5),currentSheet.insertRow(i),currentSheet.deleteColumn(j),currentWorkspace.insertSheet(“sheetname”),currentSheet.rename(“new”),currentCell.getType( ),currentCell.is Type( ).

Application Programming Interface

Any arbitrary Java object can reside in the invention cells. For example, to create a cell that holds a Vector object from the standard Java Development Kit (JDK), all one need to do is:

$$A 1 \text{:} = new ( '' java . util . Vector '' )$$

Once a cell is holding a Java object, one can call methods in expressions or code blocks.
For example,

$$A 2 \text{:} = A 1. size ( ) * 5 + 2$$

$$A 3 \text{:} \{ A 1 ! addElement ( '' J 2 '' ) ; \}$$

$$A 4 \text{:} = 0$$

$$A 5 \text{:} on ( A 1 ) \{ A 4 = A 4 + 1 ; \}$$

Being able to create objects from arbitrary Java classes, whether it is from the standard Java packages or it is written from scratch by Java developers, and to be able to use these components in expressions or code blocks adds a lot of flexibility to the invention.

However, there may situations where one would like ones objects to trigger cells from external events, i.e. events originating outside the spreadsheet pushing updates into spreadsheet cell. For example, when monitoring an external remote process, events produced by that process may need to trigger other cells in the invention. The invention allows one to develop more sophisticated objects that will allow one to do this and more.

In order to use the invention to trigger cells in the invention, the easiest way is to extend the abstract component class, once one extends this class one needs to call super( ) in the constructors of ones class to make sure that appropriate initializations are made. To trigger change events all one need to do is call the fireComponentChange method when it is desired to push updates into the cell. Parameters to this method are an event identifier, which is typically a String object to identify the property changed, and old and new values for the property.

Another important functionality provided by the invention is the ability to define ones own interactors. Basically, when there are no interactors specified an object is rendered simply by getting the output from the toString method of the object. For most objects this may be sufficient, but there are cases where one would like to create ones own interactive objects or visualizations when one may need more graphical input and output in ones application. In such cases one need to develop an interactor class for the component.

The process for creating custom user-defined interactors is simple. Essentially, one will first need to create an interactor class and associate the interactor developed to the component class. The interactor class essentially has certain methods that are called from the user interface when the sheet is being rendered.

A getDefaultSwingInteractor method of the interactor is called to create an Swing component (derived from javax.swing.JComponent) that is used to render the component within cells. The updateSwingInteractorFromComponent method of the interactor is called just before rendering to update the specific Swing component to reflect possible changes in the component being rendered. Likewise updateComponentFromSwingInteractor is called to reflect changes in the interactor back to the component itself. This is needed when the user has interacted with the interactor and such changes need to update the component interacted. Parameters to these methods are component (java.lang.Object), the component being interacted, and interactor (javax.swing.JComponent), the Swing interactor that performs the actual rendering and handless the interaction.

Implementing the updateSwingInteractorFromComponent method may be sufficient for just rendering purposes, but to enable interaction with the component, the interactor class needs to implement listenSwingInteractor and unlistenSwingInteractor( ) methods and the is ValueInteractor( ) and getDefaultClickToStart( ) methods in addition to updateComponentFromSwingInteractor methods as mentioned above.

Essentially interaction with an object works as follows: First, a Swing interactor is created through either getDefaultSwingInteractor or getSwingInteractor methods. Then, the platform specific interactor is updated to reflect the component using the updateSwing-InteractorFromComponent method. Then the Swing interactor events are listened in the listenSwingInteractor method. At this stage the swing interactor is ready for interaction. In the listener event notification methods (such as actionPerformed) one will need to call one of the following methods: handleInteraction, stopInteraction, and cancelInteraction. The handleInteraction method will report the event and cause appropriate notification of the interaction event and cause triggering in the spreadsheet. The stopInteraction method will report the event but additionally will stop interaction. The cancelInteraction method simply stops interaction without reporting the interaction event. After the notification of the interaction event the updateComponentFromSwingInteractor method is called to reflect the interaction on the component. Finally, unlistenSwingInteractor method is called to unregister the listeners for the Swing interactor.

System Administration

The invention comes with a rich set of graphical user interface, visualization, programming, and system components that can be combined easily and quickly to develop system administration tools.

The invention supports many of the system management APIs such as JMX, SNMP, JDBC and other means to connect to remote servers and data services using SSH and WebServices.

Tools developed by the invention can be deployed to execute in portal runtimes thus enabling tool sharing on the web. Moreover, system administrators can reuse the code of deployed tools to provide further customizability of deployed tools for their own environments. The inventive spreadsheet programming model is designed to be straightforward and flexible enough to support reuse where users can start from the code of the deployed tool and modify and extend it for their own particular use.

The invention, leveraging the resilience, ease-of-use, shareability, reusability, and straightforward programming model of spreadsheets, cuts down system administration tool development time, and improve effectiveness as system administrators configure, troubleshoot, and administer systems their own way, benefiting from the best of the command-line and graphical interface worlds.

The invention devises a method and system for improving interaction of spreadsheets with external data sources and processes. The invention allows users to create cell objects that represent external data sources and processes. Such sources and processes are essentially first-class cell objects that can be referenced in spreadsheet expressions and command blocks to control and query properties of such data sources and processes.

Cell objects representing external data sources and processes provide functions that may be used to retrieve state information or change behavior of the external system. Other cells may use these functions in expressions to monitor or affect the external system. For example, if cell A1 represents an air conditioning unit process it is possible to inquire about the current temperature by calling the getCurrentTemperature( ) function of the air conditioning unit in a spreadsheet expression. These functions can be used to build arbitrary complex spreadsheet expressions which are automatically reevaluated as a result of external events in the dependent external data sources and processes.

Operations on these external data sources and processes can be performed in command blocks through calling methods defined by the processes in spreadsheet cells. For example, if cell A1 represents an air conditioning unit it can be turned on by calling the turnon( ) method of the unit. Additionally, users can code command blocks that can be triggered automatically upon meeting specified conditions to perform operations on these processes and further trigger reevaluation of subsequent dependent spreadsheet expressions. For example, command blocks can be written to automatically turn on the air conditioning unit when the temperature is above 100 degrees Fahrenheit.

If desired, such data sources and processes can be rendered graphically in the spreadsheet. For example, an air conditioning unit that is operating can have a graphic animation to indicate that it is turned on. Likewise, editors can be defined that allows users to interact with such processes graphically. For example, an air conditioning unit can be edited through a graphical control unit which has switches and dials that are displayed in the spreadsheet cell containing the unit.

In summary, the inventive methods provides the below advantages over existing approaches representation of external data sources and process as first-class cell objects, improved language syntax and semantics to use such objects and their functionality in spreadsheet expressions, support both push and pull mechanisms for data transfer between the spreadsheet and external data sources and processes, and, mechanisms for graphical control and visualization of external data sources and processes.

The present invention comprises several components: (1) a spreadsheet user interface for programming and executing spreadsheet programs, (2) a computational back-end that connects the spreadsheet program to the IT systems that the sysadmin is responsible for administering, and (3) means for storing, sharing, accessing, modifying, and executing spreadsheet programs between sysadmins. Together, these components provide a spreadsheet programming environment that is tailored for use by system administrators.

The invention is of particular value to sysadmins because the invention provides a programming environment that is able to scale in complexity from very simple calculations to highly-complex system management functions. The invention connects to current work practices by connecting to legacy systems and existing sysadmin scripts without modification. The invention also provides an integration point for converging the disparate systems over which a sysadmin has responsibility. System manufacturers cannot possibly foresee the wide range sysadmin work environments, but the spreadsheet environment provides a place for sysadmins to custom-tailor a workspace for their individual needs. The following examines some of the system management APIs.

JMX

Java Management Extensions (JMX) technology is one of the standard programming interfaces for configuring, managing, and monitoring devices, applications, services, and systems. At the core of the JMX standard are MBeans, which are essentially Java objects that implement interfaces to list and execute the methods for all exposed attributes and operations of the managed resource.

The invention utilizes the JMX API to connect to systems that implement JMX interfaces for system management. Essentially, MBean objects can be assigned to cells and users can query the exposed attributes as functions in expressions and perform the exposed operations in code blocks. For example, to open a JMX connection to a server, one would write:

A1: new(“JMXConnection”, “server”, “port”, “login”, “password”)).

In the invention, JMX connections to common systems are exposed through system-specific objects. For example, a JMX connection to WebSphere Application Server (WAS) can be created by:

A1: new(“WAS”, “server”, “port”, “login”, “password”))

Once an object representing a JMX connection to a server is created, functions and operations can be used in expressions and code blocks. For example, to get the JVM Heap Size attribute from WAS, one can write:

A2: =A1.getHeapSize( )

Note, that this is very much the same way one would call the functions and operations on components seen earlier. From the users perspective there isn't any difference in terms of what technology is being used underneath to make connections to systems. A Resource Monitoring Tool.

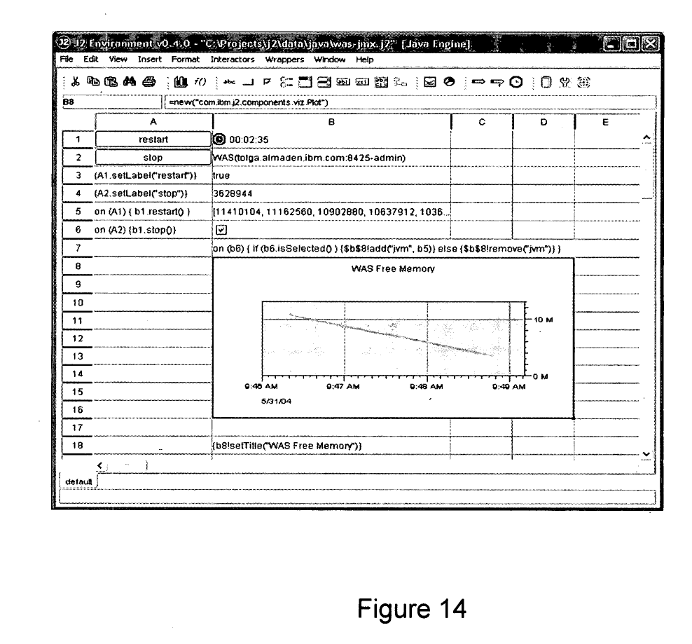

In this example, the invention works on building a tool that connects to an WebSphere Application server through JMX and monitor its JVM Heap free memory through a plot visualization, as shown below. The invention will also develop a notification mechanism and create custom notifications sent through email when user specified conditions are met as shown in FIG. 14.

First, the invention will need to open a JMX connection to WAS:

B2: new(“WAS”, “server”, “login”, “pwd”)

Next, the invention would like to create a timer to pull JVM free memory size from B2 on regular intervals, in this case every 5 seconds:

B1: new (“Clock”, 5000).

In this example, the invention adds some buttons to start and stop the timer:

A1: new (“Button”, “start”)

A2: new (“Button”, “stop”)

A5: on (A1) {B1.restart( );}

A6: on (A2) {B1.stop( );}

Before querying WAS for JVM heap free memory the invention needs to create a component to hold free memory data at each time tick. Since the invention would like to time stamp data the invention would preferably use a TimedNumberCollection:

B5:new(“TimedNumberCollection”)

Then, the invention can query WAS for JVM heap free memory on every time tick and add the data to the collection in B5:

B3:on (B1) {b4=b2.getFreeMemory( ); b5 ! add(b4)}

This kind of data easily lends itself to plot like visualizations, where the invention can show the free memory data versus time nicely. To create a plot one would code:

B8: new(“Plot”)

Plot component has various operations defined to add, remove data, as well as set title. To set the title of a Plot, one can use the setTitle( ) operation:

B18: {B8.setTitle(“WAS Free Memory”)}

Optionally, the invention can create a check box to add and remove the data to and from the Plot:

B6: new(“CheckBox”)

Last, the invention will use add( ) method of the Plot component to add data to the plot. add( ) method takes two parameters. The first parameter is the name of the data and the second is its value. Add the free memory data to the plot when the checkbox is checked and remove it when unchecked:

F6: when (B6.1s Selected( )){B8.add(“free”, B5)} else {B8.remove(“free”)}

While visualization may provide quick insight into a developing problem it may not be sufficient. Typically, administrators of systems also want to receive email notifications when problems occur. To extend the above example to send a notification email when the space utilization of a resource reaches 90%. That corresponds to a free memory of less than 10%. First, the invention needs to get the total heap size. Note, here, the invention doesn't need to collect heap size in a collection:

C3: on (B1) {C4=b2.getHeapSize( );}

Next, the invention would like to create a mail service, and set the mail server:

F2: new(“MailService”)

F3: {F2!setServer(“your mail server”)}

Lastly, the invention needs to create the inventive custom notification logic to send email:

F10: if(B4/C4<0.1){F2.sendMail(“from”, “to”, “alert”, “check JVM”}

SSH

SSH is a protocol suite of network connectivity tools that allow users to log into a remote system and execute commands on a remote system through secure encrypted communications between two systems over an insecure network. SSH is increasingly becoming popular due to the security it provides over its alternatives.

The invention allows users to open an SSH connection to systems and execute commands on the system. To open a connection the user needs to create an SSH object:

A1: new(“SSH”, “server”, “login”, “password)

Once an object is created the user can simple execute command through the runCommand( ) function SSH object provides runCommand( ) function returns the output of executing the command that is passed as a parameter. For example, to run “ps” on a remote server, the user need to code:

A2: =A1.runCommand(“ps”)

The invention provides various output processing functions such as splitLine( ) which essentially takes output and separates each line and puts them in a collection. Once the output is in a collection, dist( ) operation can be used to distribute the contents of the collection over multiple cells.

Using SSH system administrators can run their existing scripts through the invention, and pull results back into the invention for further computation or tool building. This way existing scripts can be seamlessly integrated into the invention and further enriched through graphical user interface components and visualizations. Furthermore, these tools can then easily be turned into portlets. This is demonstrated through a simple example.

A Simple Database Tool

In this example, the invention will execute an existing script on a system through an SSH connection. The script, which creates a tablespace on a database server, is already created and stored in the system. In this example, the invention will essentially create a graphical interface to this script where parameters necessary for the script will be read from textfields.

First start by opening an SSH connection to the system:

A1: new(“SSH”, “server”, “login”, “password)

Next, the invention creates two textfields, one for the database name, and another for tablespace name, which will then in turn passed as parameters to the createTableSpace.bat script on the system for creating the tablespace for the specified database.

A2: =“Database Name:”

B2: new(“TextField”)

A3: =“TableSpace Name:”

B3: new(“TextField”)

Lastly, the invention will create a button. Upon pressing the button it will execute the script, once the parameters for the script are in place.

B4: new(“Button”)

B5: on (B4) {A1.runCommand(“createTableSpace.bat”+“ ”+b2.getText( )+“ ”+b3.getText( ));}

Spreadsheets in System Administration

One major drawback of current spreadsheet packages is regarding interaction with external data sources and processes. This is particularly important for system administration as most of the objects users deal with have runtime environments outside of the spreadsheet.

In commercially available spreadsheet packages typically data is first dumped into a file and then imported in a spreadsheet application where data is populated into various cells. Sometimes users have to even manually input their data into spreadsheets. On the other hand the volume of data and real-time processing requirements may severely limit spreadsheet use in certain application domains. For example, system administrators who need to monitor system performance may not have the capability to enter data at the rate and volume produced by the systems. In other cases importing data from files into a spreadsheet application fails the real-time requirement. Similar problems also arise in interaction with external processes. External processes can also import data into spreadsheets, either in a pull or push model. Data in spreadsheets can also be used to control the properties of external processes in real time.

Today, using spreadsheet programs like Excel users can write Visual Basic programs interact with external data sources and processes into spreadsheets. Excel also provides built-in mechanisms/interfaces to directly import data from external data sources such as databases. While this approach seems to work it has major drawbacks. First, these data sources and processes are not explicitly represented in the spreadsheet application as first-class spreadsheet cells. Thus, interaction with these sources and processes is done typically using another programming language (such as Visual Basic for Excel) which is typically beyond the skill levels of most spreadsheet users. Alternatively, users can use the built-in mechanisms to import data but this typically limits the functionality of what users can do. Second, functionality provided by the external process may not be exposed to the user in the form of functions that the user can use in the familiar spreadsheet expressions to query and control process properties. Third, such programming languages have a different programming model than the spreadsheet expressions such as in Excel. Lastly, data is pulled out of external data sources and processes as opposed to actively pushed by these sources and processes for triggering cell updates.

Spreadsheets, familiar to many, have attracted many as a presentation metaphor, including for system management. For example, moodss (Modular Object Oriented Dynamic SpreadSheet) is a graphical monitoring application that utilizes spreadsheet like tables displaying module data interfaced to external systems. Moodss is composed of a main part and a number of modules, loaded as the application is launched, each module interfacing to specific type of data. The module function is to describe the data that it is also in charge of retrieving and formatting. Modules can be written in a scripting language such as Tcl. Several modules can be loaded and handled concurrently allowing system administrators to monitor data coming from a number of heterogeneous sources. Yet, each module is in its own table thus integration of data visually is limited. Though moodss utilizes spreadsheets as a presentation metaphor it lacks to incorporate a spreadsheet language for creating the modules dynamically.

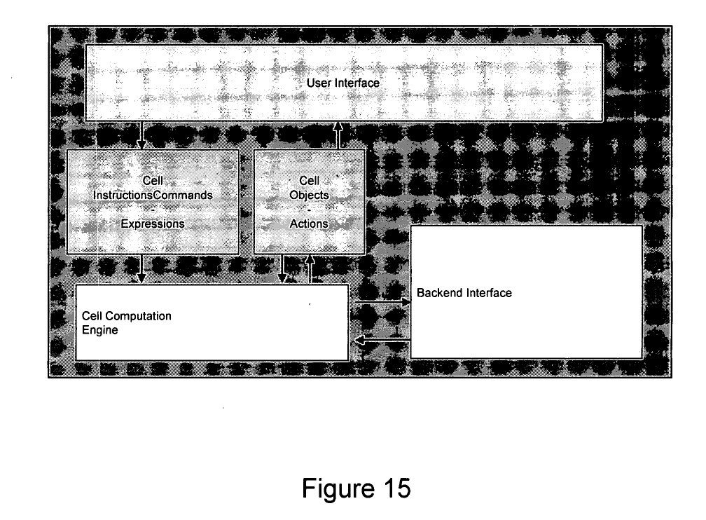

From an architectural standpoint, the invention can be studied from three perspectives: the user interface, the engine, and the backend interface, as shown below. Basically, through the user interface users create objects, expressions, and commands as well as interact with the objects created. These actions are then passed to the engine. There they are processed with the help of the backend interface which monitors and controls backend systems. Once the results are computed by the engine, they are sent back to the user interface and displayed accordingly as shown in FIG. 15.

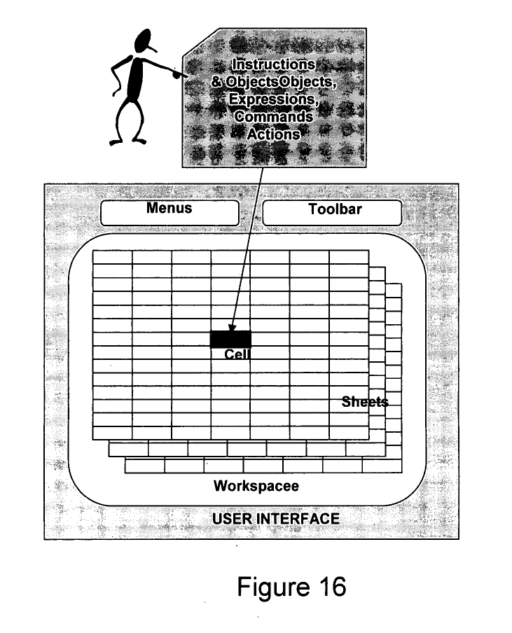

The invention user interface consists of menus, toolbars, and a workspace. Using the menus users can perform basic actions such as opening and closing workspaces, creating and deleting sheets, deleting, copying and pasting cells, etc. The toolbar consists of a set of buttons and provides a convenient way to create objects upon clicking respective buttons. The workspace contains sheets which contain cells. Cells, as in most spreadsheets, are organized in a grid structure that follows the cell addressing scheme, where rows and column indices are paired to yield the cell address. Optionally cells can also have a user-defined cell name. A workspace is a coherent unit of work, written to and read from storage as shown in FIG. 16.

Users can create objects either through the toolbar or by coding them directly into the cell. Expressions and commands are likewise coded into a cell, and they are then passed to the engine. Engine processes them and returns the results back to the user interface. Upon receiving results, the user interface renders the resultant objects based on the type of the object defined in the interactor table.

The mapping of the object types to interactor components can be defined by the user. For most common objects, however, this mapping is defined by default and can be changed by the user if desired. For example, a CheckBox object is mapped to a JCheckBox interactor component when it is rendered in the invention user interface. Note that entries in the interactor table are platform dependent (e.g., client gui, web, etc.). Thus, when the execution environment is the web, for example CheckBox object is mapped to a WCheckBox interactor component when it is rendered in the invention portlet.

Some objects also have interaction capabilities, such as the CheckBox object. When rendered as a JCheckBox essentially users can interact with the CheckBox object, such as clicking to change the selected status (e.g., checked vs. unchecked). Events generated from the interactor component, JCheckBox modify the underlying object, CheckBox, and the engine is notified further to trigger dependent expressions to reevaluate or commands to reexecute. The following describes this process step by step in detail. First, the spreadsheet receives an action event (e.g., mouse button press) at a particular location on the sheet. The corresponding cell is located (e.g., B4) and the matching interactor component (e.g., JCheckBox) is determined by a lookup in the interactor table corresponding to the object (e.g., CheckBox) contained in the cell and the execution platform (e.g., client gui). When there is no assigned interactor component, as in the case of no existing object in the cell (e.g., user clicks on an empty cell) a default code editing interactor component is returned that will allow the user to enter code. The state of the object is (e.g., selected status: checked vs. unchecked) copied over to the interactor component so that the interactor component renders an up-to-date state of the object it represents. An event listener is registered for the interactor component actions (e.g., selection action). An interactor component is displayed and the action event (e.g., selection action) passed to it. The corresponding event listener is notified upon receiving the event (e.g., selection action event). State of the interactor component is modified accordingly (e.g., selection status toggled from unchecked to checked or vice versa.) The state of the interactor component is copied over to the object. The event listener is unregistered. The engine is notified for possible triggering of dependent expressions to reevaluate or commands to reexecute. Some of the interactor components can be marked as delayed interactor components. Such components do not immediately cause an action that can be listened due to the platform-specific user interaction style, for example, in the web platform a WTextBox component corresponding to a TextBox component. When the user interacts with the WTextBox component by entering text it does not immediately cause an action due to the form-based interaction style found on web pages. However, afterwards when the user interacts with a non-delayed interactor component, such as a WButton, first delayed interactors are processed, and last the non-delayed interactor is processed. In such cases when a sheet is rendered all delayed interactors are noted. When a non-delayed interaction occurs, first delayed interactors are processed to examine if there has been any interaction, if so they are processed using the above steps before the non-delayed interactor is processed. This approach essentially allows the invention to accommodate the form-based web interaction style much like the event-based client gui interaction style.

This aspect of the invention is a technique to convert standalone Swing GUI applications to HTML forms based GUI. Essentially this is used when converting the tool built in the invention development environment into a web portlet. There are significant differences between the interaction models of standalone event-based applications and form-based client-server applications on the web. The invention needed a single language to drive both interaction models. In the standalone case, users interact with graphical components, immediately generating events that may cause the components to be re-rendered to reflect changes. In the web model, components are contained in forms that are submitted and processed by the server. The problem is that not all components can cause the server to process and refresh the page. The design of the web model makes sense given long roundtrip delays in client-server architectures: users interact with a form composed of multiple input widgets, submitting all changes at once to minimize roundtrips.

The invention handles these two different models through abstract graphical components with platform-specific interactors that perform all rendering and interaction. In the web case, components that do not support a submit event are considered “lazy” components. When the portal page is initially rendered, such components are registered with their current values. Upon interaction with non-lazy component, lazy components with changed values are processed first, allowing event listeners to process events for lazy components. This approach allows the invention to accommodate the form-based web interaction style much like the event-based standalone graphical interaction style in the same event-based programming language and model.

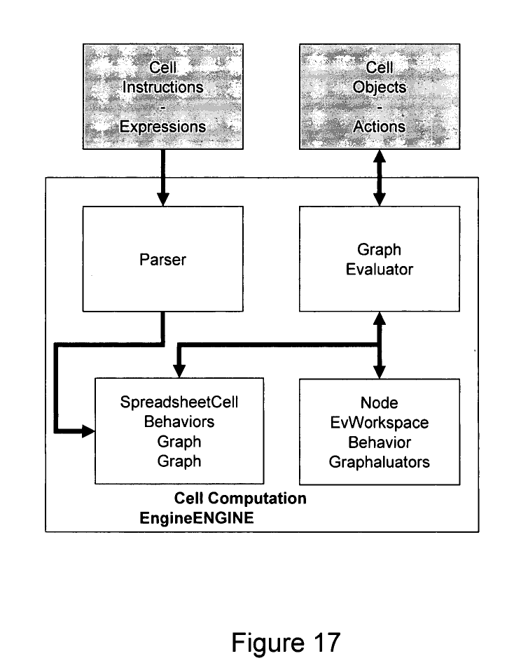

The execution model in the invention fits very well with the spreadsheet model. The invention extended it to provide an object-based approach for programming. Basically, when new code is entered by the user to create objects, to define expressions, and commands, they are passed to the engine. The parser in the engine parses the code and generates a graph of cell behaviors, which manage the objects in cells, for the current cell and adds it to the workspace behavior graph. The graph evaluator manages the whole graph triggering cells to reevaluate or reexecute whenever their value or one of their dependents changes value, as shown in FIG. 17.

The following examine cell behaviors in more detail as they are central to the workings of the engine. A cell behavior essentially manages the object in the cell, including ensuring proper reexecution of code when affector cells get updated and proper triggering of dependent cells for their turn to reexecute and propagate update upwards.

A cell behavior essentially holds the object residing in a cell, accessible through a cell reference; the function that operates and/or evaluates the object; a list of dependent cell behaviors and a list of affector cell behaviors.

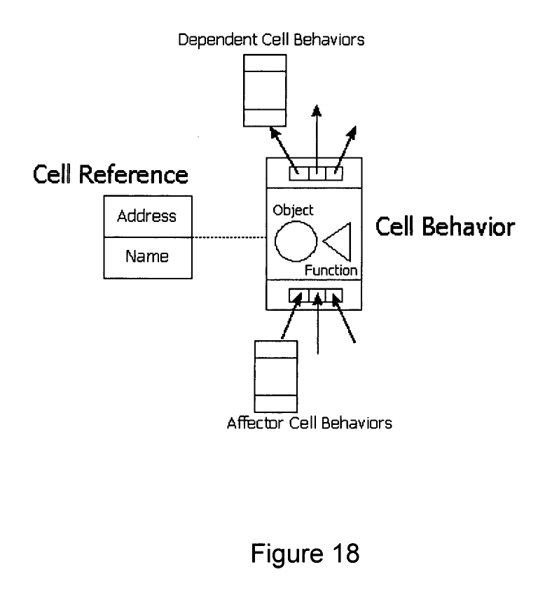

The basic mechanism is that when a cell is triggered through changes to any of the affector cell behaviors the function will be applied on the object and further update propagation will be triggered for all of its dependent cell behaviors so that they will also get a chance to update their objects, if necessary, as shown in FIG. 18.

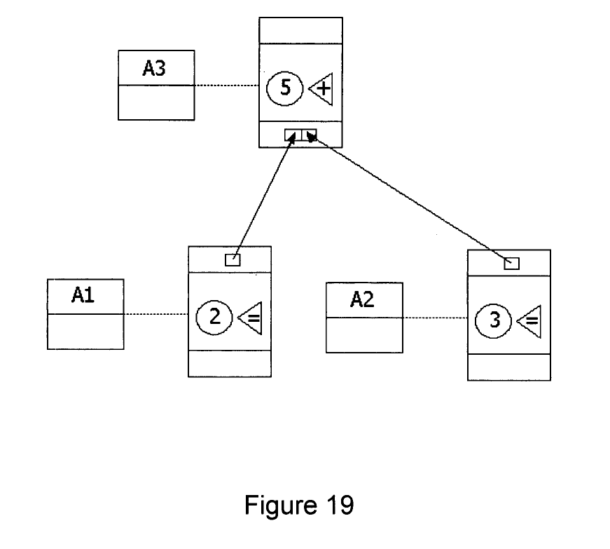

Looking at a simple example, A1 and A2 is assigned to numbers 2 and 3, respectively. Both cell behaviors in this case are rather simple, the objects representing the numbers and the constant function are the only elements of the cell behavior. Afterwards the user enters the expression=A1+A2 for cell A3. When the expression is parsed the cell behavior for A3 will be linked to cell behaviors for A1 and A2 as affectors. As a result of evaluating the expression the number 5 will be put as the object for cell A3. Since both behaviors are listed in the affector cell behaviors for A3, changes to either A1 or A2 will propagate upwards and cause a reevaluation of the expression in A3 to yield the new number for A3, as shown in FIG. 19.

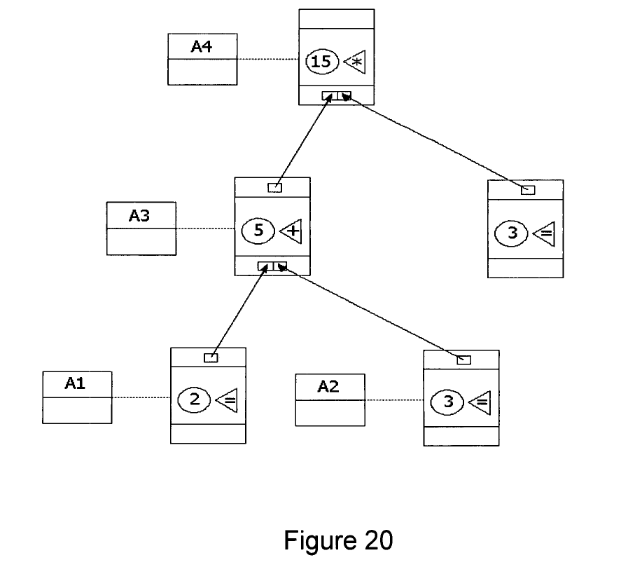

Continuing with the above example, the user adds another expression for A4, i.e. =A3*3. As shown below, this will also be linked to two behaviors, one representing cell A3 and the other the constant number 3. If the user then changes the value in A1, this change will be first propagated to A3 and then consequently to A4, as shown below, as shown in FIG. 20.

To accommodate object functions and operations in cell expressions and code the invention link the function in the cell behavior construct to other cell behaviors which provide the object to operate on or evaluate for as well as the parameters for the functions and operations.

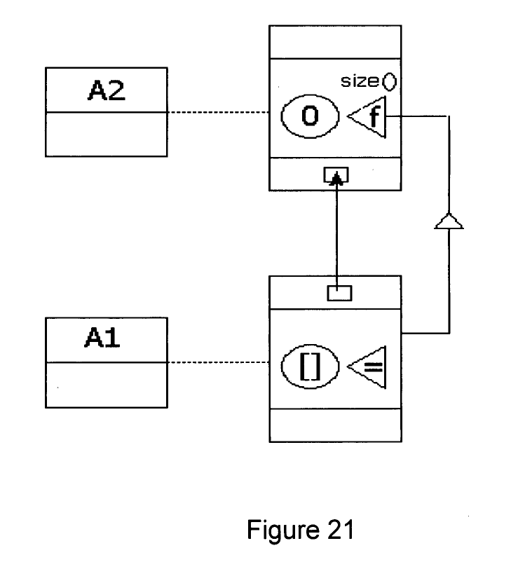

Below is a simple example for an object function expression. In this case A1 is assigned to =new(“ObjectCollection”) and A2 is assigned to the expression A1.size( ). As seen below when the expression for A2 is entered the A1 is listed as the affector cell behavior for A2, since the invention wants to update the object for A2 when A1 is updated. However, in addition A2 is also linked to A1, since A1 is the object the size( ) function in A2 is evaluated for, as shown in FIG. 21.

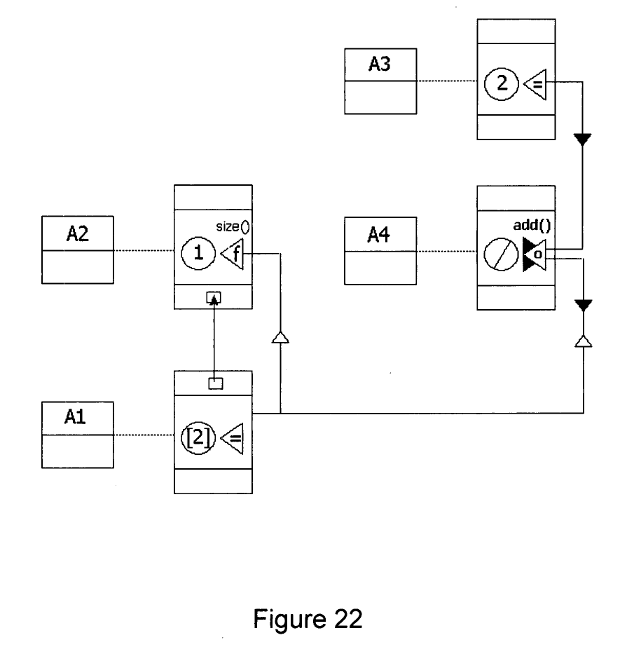

Extending the previous example with an object operation, the user adds the code {A1!add(A3)} for A4, which has a cell behavior construct where the add( ) function is linked to A1 and A3. A3 provides the parameter and A1 provides the object to operate on. When A4 is executed the object in A1 is updated and the cell behavior for A1 is notified about the change. As a result of this triggering is initiated for the dependent cell behaviors in A1, which only holds A2. Consequently, A2 is reevaluated to reflect the new size for A1, as shown in FIG. 22.

Essentially, the engine is triggered in three ways: a) user enters code for creating new objects, defining an expression or code, b) user interacts with an object, typically a graphical user interface object, c) the object itself initiates triggering, typically when the object represents a process that is updated externally and engine is notified. The following describe each step by step in detail.

First, look at what happens when the users enter new code, or modifies code in a cell. First the invention parses the code for the cell, and creates a behavior graph for the cell. Next, the invention checks the cell behavior graph for cycle. The invention then reports error in the case of a cycle. The invention connects the cell behavior graph to the overall workspace behavior graph by connecting the affector and the dependent behaviors. The invention checks for a cycle in the workspace behavior graph, report error in the case of a cycle and disconnects cell behavior graphs. The process shows the cell behavior graph. In the case of an object creation, the invention creates an object instance of type specified by the user. The invention marks all cells behaviors in the dependent cell behavior list of current cell dirty. The invention recursively goes up the dependent cell behavior list mark cells dirty. The invention triggers reevaluation of dirty behaviors starting from the dependent cell behavior list, recursively, marking behaviors clean once they are reevaluated. In the case of an expression definition, the mark all behaviors in the cell behavior graph for the current cell dirty. The invention evaluates dirty behaviors, while marking behaviors in the dependent cell behavior list dirty. The invention triggers reevaluation of dirty behaviors, marking behaviors clean once they are reevaluated. In the case of command definition, the invention marks all behaviors in the cell behavior graph for the current cell dirty. The invention evaluates dirty behaviors, while marking behaviors in the dependent cell behavior list dirty, as well as the behaviors representing cells upon which operations are performed. The invention triggers reevaluation of dirty behaviors, marking behaviors clean once they are reevaluated.

Next, examine the procedure for handling gui actions forwarded to the engine. Note that the following procedure describes steps after the engine receives the action. Prior steps were described in the user interface section of the architecture description. The invention locates the reference to the gui object. Using the reference locate its cell behavior graph. The invention processes the cell behavior graph. The invention marks all cells behaviors in the dependent cell behavior list of current cell dirty. Recursively going up the dependent cell behavior list mark cells dirty. The invention trigger reevaluation of dirty behaviors starting from the dependent cell behavior list, recursively, marking behaviors clean once they are reevaluated.

Processing of the external process actions is similar to the handling of the gui actions, as described below. The invention locates the reference to the object that triggers action. Using the reference locate its cell behavior graph. The invention processes the cell behavior graph. The invention marks all cells behaviors in the dependent cell behavior list of current cell dirty. The invention recursively goes up the dependent cell behavior list mark cells dirty. The invention triggers reevaluation of dirty behaviors starting from the dependent cell behavior list, recursively, marking behaviors clean once they are reevaluated.

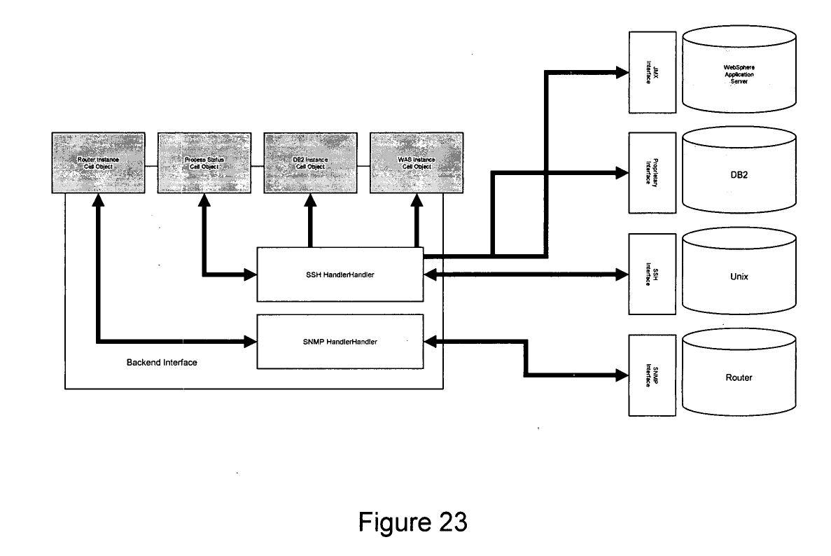

The invention allows users to query and control external processes, pretty much like working with any local objects. The invention utilizes various standard system management APIs to connect to external processes on remote systems. Using these APIs process configuration and run-time status can be pulled into the invention cells through expressions. Furthermore these processes can be remotely controlled through commands in various cells. Basically communication with external processes is managed through objects that represent the connection to the process. Depending on the system management API these objects can utilize handlers that manage the connection, as shown in FIG. 23.

The invention supports both push and pull models to communicate with remote processes. In the pull model data is pulled from the external processes, i.e. client-initiated by issuing commands to the remote system. In the push model data is pushed from the remote process, i.e. server-initiated, into the engine for deriving further triggering.

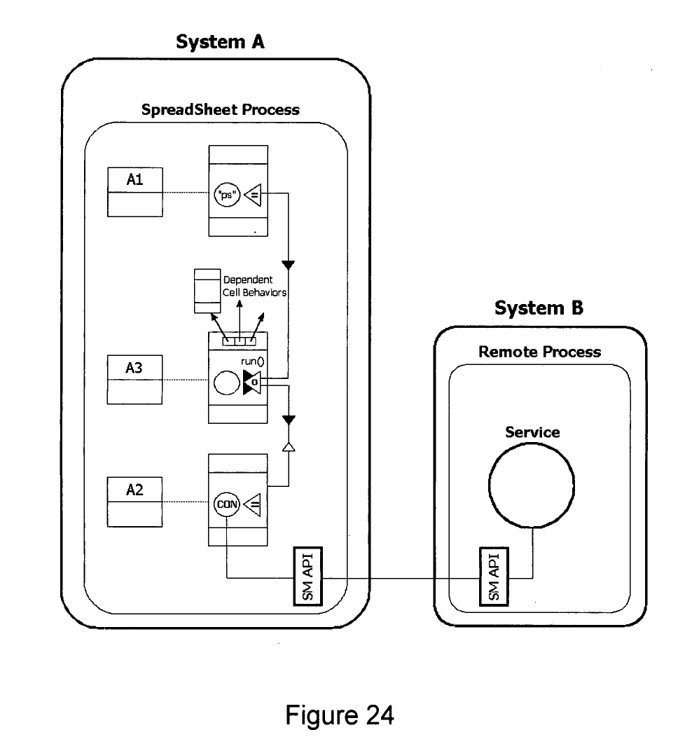

Examine the example below which demonstrates the pull model. In this example, an SSH connection is made to a remote server to run a command and display the results. A1 contains the command, i.e. =“ps”, A2 is the SSH connection to the remote server new(“SSH”, “server”, “login”, “password”), and A3 makes the call to execute the command using SSH. Once the call is made, i.e. run( ) operation is performed on A2, the SSH connection object forwards the request to the remote process through the SSH Handler. When the result is ready from the remote process it is forwarded through the SSH Handler back to the SSH connection object, which in turn propagates the result to the object in A3, as shown below. It is important to note here that the application and the remote process are running on different computer systems, System A, and System B, respectively, as shown in FIG. 24.

Now, examine another example where the remote process triggers the engine in the push model. In this example, a JMX connection is made to a remote server, which from time to time sends updates to the engine. In this case A2 contains the JMX connection to the remote server new(“JMX”, “server”, “login”, “password”), and A1 contains the expression that displays some status information on the remove server, =A2.getFreeMemory( ). In this case no particular call is necessary to the remote server object to query status since it is externally driven by the process. A2 object upon receiving an external action simply passes it onto the engine and dependent expressions and code on A2 are reevaluated and/or reexecuted. A handler is utilized in this case too, where the remote process first notifies the JMX Handler and passes it onto the object that represents the connection. That object then passes the action onto the server. Here too the inventive application and the remote process are running on different computer systems, System A, and System B, respectively.

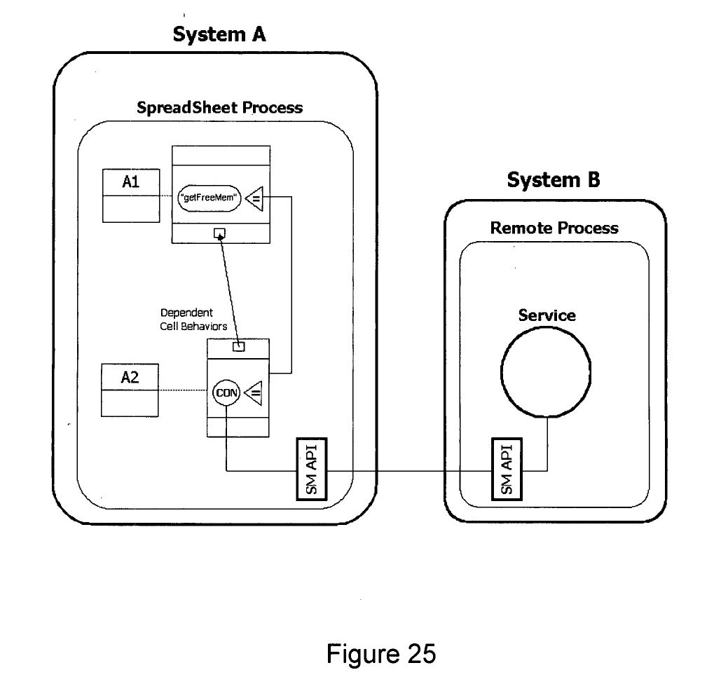

The runtime execution environment for the web platform is similar to the runtime environment for the development environment, see FIG. 25. Fundamental differences are that the users can no longer define expressions or commands for cells. Therefore the user interface no longer has the toolbar that was used for entering new code into cells nor are the existing cell code editable. Likewise users cannot create new objects but objects can be sent back to the user interface for interaction purposes. Essentially these objects are matched with the appropriate interactor components and presented to the user for interaction, as shown in FIG. 25.

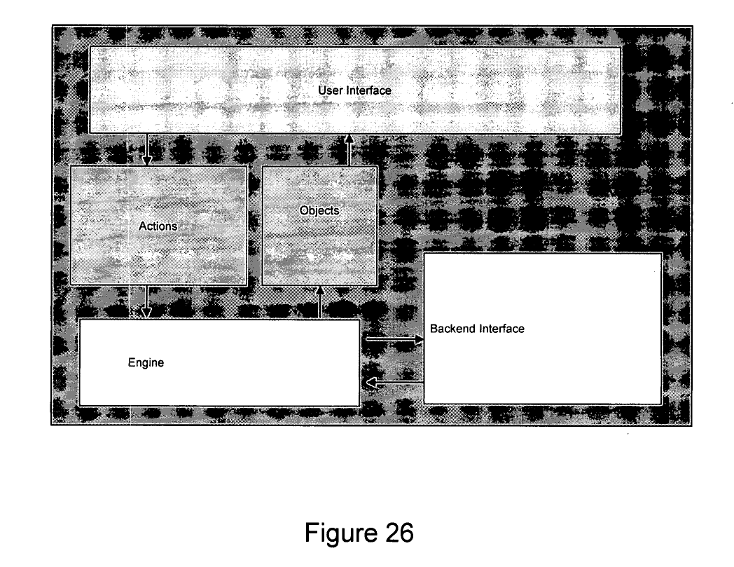

Each deployed tool runs in its own engine and displayed through portlet windows, which is responsible for rendering and interaction of the components (e.g., actually conversion to HTML for rendering by the web browser) as shown in FIG. 26.

Based on this and other cases observed, the invention sees several requirements for effective end-user programming for system administration. The invention collaborates through shared workspaces and a highly reusable programming language. The invention creates simple task-specific language that allows integration of information from various components. The invention supports for rapid development of custom tools in a flexible and powerful way, as in command-line interfaces, but that also facilitates rich visual representation of data, as in graphical user interfaces.

The invention now examines its (1) spreadsheet-based visual environment, (2) sysadmin-specific task language, and (3) web portal-based collaboration support. The invention also discusses how the invention addresses these requirements as well as criteria for successful end-user programming.

To support system administrators' needs for control of external systems, the invention adopts a component-based approach (also see [13]). The invention provides a library of components that can represent rich data types (e.g., collections, queues, stacks), connections to external systems (e.g., Secure Shell or SSH or JMX™), graphical widgets (e.g., Button, TextBox, ComboBox), and visualizations (e.g., X-Y plot, pie chart). These components are available from the toolbar to allow the user to point and click to connect to servers, for example. Components are essentially objects, with multiple properties (state) and operations (behavior).

The invention extends the spreadsheet language to include method calls to perform operations on components, and permits formulas to refer to components to query their properties. For instance, cell A2 can contain a component for a system resource, and cell A3 can contain the expression “=A2.getFreeMemory( )”. Some component operations may require parameters, which are specified using the same spreadsheet formula language. The invention uses weak typing when matching objects to parameters. For example, numbers are automatically converted to strings and vice versa depending on the context and operations involved.

The invention supports the use of any Java object as a component. The invention believes the success of the invention will depend to a large degree on its containing a rich set of domain-specific components. To facilitate this, the invention provides a plugin architecture for creating new components. Once developed, new components can be used just as built-in components in code and expressions for controlling and querying systems. Additionally, each component may also implement interactors that specify how it will be rendered on the screen, and how the user may interact with it. Components can be rendered textually or graphically (e.g., an X-Y plot).

A fundamental strength of spreadsheets is that cells update automatically, always displaying the current value of their expression. However, in system administration domain, sysadmins also need to execute commands that perform an action on an external system, such as deleting files or changing configuration. These actions require user control of program flow. To enable control flow capabilities in spreadsheets, the invention extends the spreadsheet language to include event-driven blocks of code. These code blocks can be triggered to execute upon events, such as changes to cell values, clock ticks, button presses, or conditions evaluating to true. When triggered, code can assign new values to cells, distribute data collections across cell ranges, call component methods, and trigger other code blocks.

The invention's event-driven code approach fits nicely with the spreadsheet metaphor, where formula reevaluations are implicitly triggered by the functional relationships specified in cell expressions. The invention builds on this and provides further constructs, such as the on( ) construct, which allows code segments to define explicit triggers based on cell-value changes. Similarly, the invention supports the when( ) construct, which triggers code based on boolean expressions.

Through these event mechanisms, users can achieve rich control flow in their programs. For example, the invention supports both push and pull models when interacting with systems. In the pull case, a command executed in the invention causes some action on a remote system, possibly retrieving a value. In the push case, an external event is propagated to the invention and triggers further evaluations and executions. For example, when (A1.is Stopped( )) {<do something>} listens to the remote system represented by A1 and executes when that system is stopped externally.

Iteration, a pain point for most spreadsheets (and programming languages), can be easily supported simply using event-driven code. Consider the following example of resetting a number of servers. A1 is assigned to a Collection, which can hold an arbitrary number of servers. A2 is initialized to 0, and A3 holds the current server, indexed by A2. A4 is essentially the body of the iteration, which reexecutes until all the servers in the collection are processed by automatically retriggering itself by incrementing A2.

A1: Collection( )

A2: =0

A3: =A1.element(A2)

A4: when (A2<A1.size( )) {A3.reset( ); A2=A2+1;}

The invention also supports aggregate operations, which can be substituted for iteration in many cases, both in expressions and code. For example, to reset a number of servers in cells A1 through C5, one would simply write on(<event>){(A1..C5).reset( )}.

To support collaboration between sysadmins, the inventive spreadsheets can be deployed as portlets in a J2EE-based system administration web portal. This portal is a tool repository and launch-pad that allows system administrators to see sheets deployed by their colleagues, run them within their web browsers, and tailor them to their own use. This feature greatly helps shared situational awareness, as different sysadmins can see the same view of the data. When a sheet is deployed to the portal and running in a web browser, the primary difference from the invention development environment is that cells are not editable and that cells containing code are invisible. The portal version contains an “Edit” button that launches the invention locally, permitting changes to the sheet, which allows sysadmins to customize shared tools for their own purposes. Once the sheet is updated it can either replace the existing tool, or be saved under a different name.

The invention is now illustrated through examples. The invention first considers the script the user worked on and shows how they would use the invention to develop this script. The invention then extends the example to show how other features of the invention offer enhanced usability and power to sysadmins.

The user's script was intended to monitor the number of connections from the http server. The user began by opening a secure shell connection to the remote system (mercury) that runs the http server and logged in as root (root, pwd). The user started writing the shell script using the vi editor. The script contained a loop with shell commands to count the number of connections and get the current date. The count and date variables were concatenated and output. Finally, the code paused for two seconds before the next iteration:

while true

do

COUNT=‘ps-ef|grep http|wc-l’

DATE=‘date’

echo $COUNT+“ ”+$DATE

delay 2

done

In the invention, the user would start by clicking on the toolbar to create an SSH connection to the server, in cell A3. In A1 the user would place a Clock to trigger code in A4 that executes the command (ps-ef|grep http|wc-l) on the server connection and puts the result in A2 every 2 seconds, as shown below:

A3: SSH(“mercury”, “root”, “pwd”)

A1: Clock(2)

A4: on (A1) {A2=A3.execute(“ps-ef|grep http|wc-l”)}

The SSH object in cell A3 is a component—one of the inventions extensions to spreadsheets. The user creates it by simply selecting cell A3 and clicking the SSH button in the toolbar. The SSH object has a menu listing its available methods—such as execute—which can be accessed with a right-click on the object.

There is also a Clock component in the toolbar. The user places a clock in cell A1 to get the current date. Since cell A2, right below A1, contains the number of connections, the spreadsheet layout conveniently takes care of output placement without involving any programming at all.

As the user enters this “program” into the spreadsheet, the user can see each cell functioning independently, correct any errors, and use standard spreadsheet point-and-click capabilities to refer to cells within the formulas. The invention sees the active SSH connection in A3, the ticking Clock in A1, and the automatically updating value in B1. Since the Clock and SSH objects are created from the toolbar, and A3.execute( )is selected from a menu, there is minimal risk of syntax errors. Besides syntax issues, spreadsheets offer many advantages to novice programmers, such as deferred variable naming, simplified input and output through tabular layout, natural control flow through events, and incremental code development. The user would not need to worry about giving names to data immediately either (though the invention supports user defined names of cells). It is just a matter of putting that information somewhere on the sheet. The tabular layout makes input and output easy. One would not need to use explicit looping constructs to repeat execution, it was simply driven through events. Another major factor in ease of use is the ability to develop tools incrementally and interactively. The user could have simply started by creating the connection and through experimentation, the user could have found the right command to get the number of connections, and then figured out how to repeatedly perform these commands.

Though this example demonstrates what the user wanted to accomplish, the invention can easily extend it to tie data extracted through command line interaction to graphical output:

A10: TimePlot( )

A5: on (A2) {A10.add(“http server”, A2)}

A TimePlot is a component that produces an X-Y plot where the X-axis is the time each point was added. A5 is another example of event-driven code. Each time there is a new value in A2, it is added to the plot with a current time stamp to the line titled “http server”. Another simple extension would be to output data to an instant message application. Automating this using the invention is simple:

B1: IM(“root”, “pwd”, “crit-sit-chat”)

A8: on (A2) {B1.send(“http “+A2+” ”+A1)}

Here, an IM object is created with the user's login and password in cell B1. Every time there is a new value, a message composed of the number of connections (A2) and the current time (A1) is constructed and sent through the IM object. If it turns out that doing this automatically causes too many messages in the chat room, it is not difficult to change it so that messages are sent on a button press:

A9: Button(“Send”)

A8: on (A9) {B1.send(“http “+A2+” ”+A1)}

A Button object is created in A9, which is used to trigger the sending of messages by simply replacing the reference to A2 by A9 in the code in cell A8.

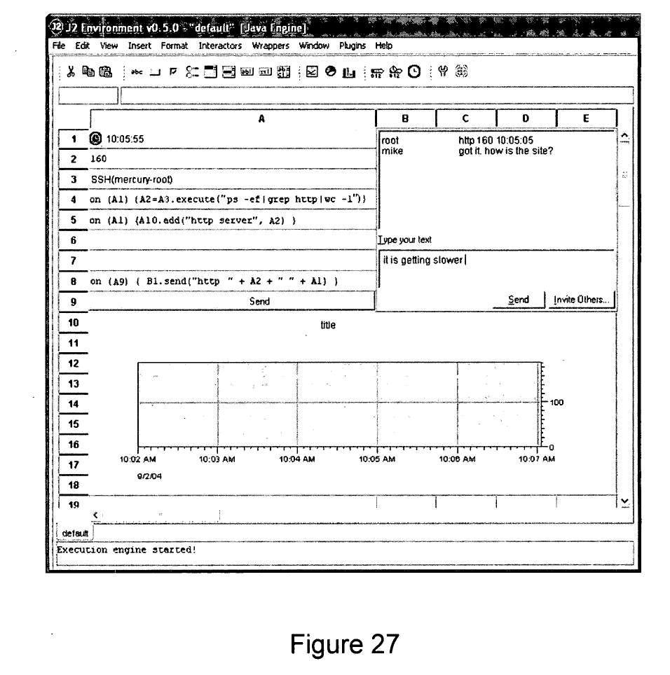

The tool developed (FIG. 3) can be deployed as the portlet, where it can be run for shared use and for further modification by colleagues. For example, it would be natural for the user to update one's tool to include the application server's number of connections in the same plot. This in fact is a major issue, i.e., effectively comparing the number of connections from these two servers, as shown in FIG. 27.

To do this, the user would simply click on the toolbar to create a different server connection (JMX) to talk to the application server, get the number of connections from the JMX by calling the getNumCon operation, and add the number to the plot under the title “app server”:

F3: JMX(“satum”, “root”, “pwd”)

F2: =F3.getNumCon( )

F4: on (F2) {A10.add(“app server”, F2)}

The new tool now displays data from both servers in a single chart as deployed to the portal (FIG. 4.) Note that unlike SSH, JMX uses a push model, where the data are simply pushed into the spreadsheet updating the value in F2. Here, the user did not even have to create a timer to drive the command execution.

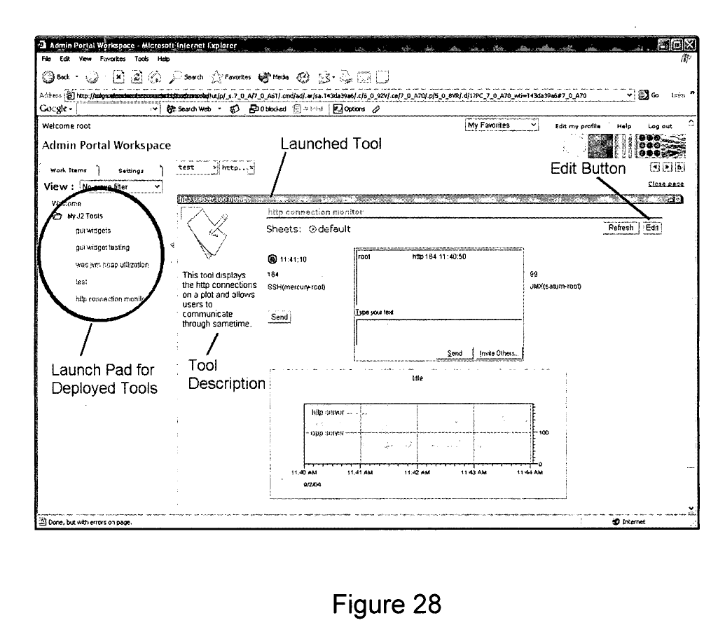

As shown, the invention's component-based approach and event-driven code technique allows sysadmins to work effectively. With the level of abstraction appropriate to the tasks of system administration, sysadmins can use a variety of components in a single sheet, and interact with multiple remote systems in an integrated manner. The portal deployment of tools enables collaboration not only in data sharing but also in tool development, as shown in FIG. 28.

The invention is a spreadsheet-based workspace meant to help system administrators manage large computer systems. It was designed to address system administrator need for integration of data from multiple back-end system components, collaboration, and customization in building their own tools. The invention extends the spreadsheet metaphor through a component-based approach and event-based programming model to provide more programming power. Through the component-based approach, system administrators can build tools that connect to remote systems, inquire about system status, and control multiple systems in an integrated manner. The event-based approach takes spreadsheets more into the realm of programming, enabling rich flow of control.

The invention's design is also in line with previous studies of programming languages [16], which show that users prefer event-based over sequential programming models, aggregate operators over iteration (the invention supports both), and graphical layout for depicting overall program structure with text to describe actual actions and behaviors (spreadsheet layout accommodates both).

This invention brings to spreadsheets many of the advantages that object-oriented programming has brought to programming languages and databases. Through an object-oriented approach spreadsheet users may achieve greater computational capability and expressive power at the same time reduce complexity and improve productivity by means of reusable higher-level objects than the basic data types without behaviors as in current spreadsheets. Object-oriented approaches yield power, elegance, maintainability, extensibility, and usability in programming for high-level solutions.

While the invention has been described in terms of preferred embodiments, those skilled in the art will recognize that the invention can be practiced with modification within the spirit and scope of the appended claims.

### REFERENCES

[1] Nardi, B. A. & Miller, J. R. (1990). The Spreadsheet Interface: A basis for End User Programming. INTERACT '90, Elsevier Science Publishers B. V. (North Holland).
[2] Yoder, A. G., Cohn, D. L., Real spreadsheets for real programmers. International Conference on Computer Languages, pp. 20-30, IEEE, 1994.
[3] Wack, A., Partitioning Dependency Graphs for Concurrent Execution: A Parallel Spreadsheet on a Realistically Modeled Message Passing Environment, Ph.D. Thesis, Department of Computer and Information Sciences, University of Delaware, 1995.
[4] Clack, C., Braine, L., Object-oriented functional spreadsheets. Proceedings of the 10^{th} Glasgow Workshop on Functional Programming, GlaFP '97, September 1997.
[5] Jones, S. P., Blackwell, A., Burnett, M., A User-Centered Approach to Functions in Excel, International Conference on Functional Programming, ACM, Uppsala, Sweden, pp 165-176.
[6] Burnett, M., Ambler, A., (1994). Interactive Visual Data Abstraction in a Declarative Visual Programming Language, Journal of Visual Languages and Computing, March 1994, 29-60.
[7] Lewis, C. H., NoPumpG: Creating Interactive Graphics with Spreadsheet Machinery. Visual Programming Environments (Glinert. E. P., Ed). IEEE Computer Society Press, Los Angeles, Calif., 1990.
[8] Hudson, S. E, Mohamed, S. P., Interactive Specification of Flexible User Interface Displays, ACM Transactions on Information Systems, Vol. 8, Num. 3, 1990, pp 269-288.

What is claimed is:

1. An electronic spreadsheet comprising:
at least one grid of cells; and
programming code statements within said at least one of said cells,
wherein said programming code statements comprise statements adapted to be sequentially applied.

2. The electronic spreadsheet according to claim 1, wherein said programming code statements can comprise statements that assign an object to a cell.

3. The electronic spreadsheet according to claim 1, wherein said programming code statements comprise statements that assign a collection of objects to a cell.

4. The electronic spreadsheet according to claim 1, wherein said programming code statements comprise statements that execute a method on an object in another cell.

5. The electronic spreadsheet according to claim 1, wherein said programming code statements comprise statements that execute a method on an object in another cell with parameters from objects in other cells in the grid.

6. The electronic spreadsheet according to claim 1, wherein said programming code statements comprise statements that execute a function on an object in another cell and assign the resultant object into the cell.

7. The electronic spreadsheet according to claim 1, wherein said programming code statements comprise statements that execute a method on a collection of objects in other cells.

8. The electronic spreadsheet according to claim 1, wherein said programming code statements comprise conditional statements.

9. The electronic spreadsheet according to claim 1, wherein said programming code statements comprise parameterizable user-defined statements.

10. The electronic spreadsheet according to claim 1, wherein said at least one of said cells comprises a block of multiple said programming code statements.

11. An electronic spreadsheet comprising:
at least one grid of cells; and
programming code statements within said at least one of said cells,
wherein said programming code statements comprise conditional statements utilizing “on” and “when” constructs.

12. The electronic spreadsheet according to claim 11, wherein said conditional statements comprise boolean expression conditions.

13. The electronic spreadsheet according to claim 11, wherein said conditional statements comprise object assignments changes.

14. The electronic spreadsheet according to claim 11, wherein said conditional statements comprise object property changes.

15. The electronic spreadsheet according to claim 11, wherein said conditional statements are made conditional on user interaction.

16. The electronic spreadsheet according to claim 11, wherein said conditional statements comprise spreadsheet events.

17. The electronic spreadsheet according to claim 11, wherein said conditional statements are made conditional on external process events.

18. The electronic spreadsheet according to claim 11, wherein said conditional statements comprise a user defined ordering of events.

19. The electronic spreadsheet according to claim 11, wherein said conditional statements comprise one of explicitly triggered statements and implicitly triggered statements by calling object methods.

20. The electronic spreadsheet according to claim 11, wherein said conditional statements comprise iterative statements.

21. The electronic spreadsheet according to claim 11, wherein said conditional statements comprise copy statements and distribution of objects statements.

22. An electronic spreadsheet comprising:
at least one grid of cells; and
programming code statements within said at least one of said cells,
wherein said programming code statements comprise conditional pause statements.

23. The electronic spreadsheet according to claim 22, wherein said programming code statement execute methods on objects using weak type matching.

24. An electronic spreadsheet comprising:
at least one grid of cells; and
programming code statements within said at least one of said cells,
wherein said programming code statements comprise statements adapted to one of:
insert programming code statements in other cells; and
modify programming code statement in other cells.

25. A method of using graphic objects in a spreadsheet, said method comprising:
mapping said graphic objects within said spreadsheet to interactor components;
receiving user interaction to activate at least one graphic object;
delaying processing of interactor components activated by said user interaction until a predetermined graphic object receives said user interaction;
processing all said interactor components activated by said user interaction once said predetermined graphic object receives said user interaction; and
reevaluating and reexecuting cells in said spreadsheet as required by objects, expressions, and commands within said spreadsheet during said processing of all said interactor components activated by said user interaction.

26. The method in claim 25, wherein said reevaluating and reexecuting of said cells is performed for all cells whenever values in corresponding dependent cells change during said processing of all said interactor components activated by said user interaction.

27. The method in claim 25, further comprising parsing said objects, expressions, and commands as they are entered into said spreadsheet to generate a graph of cell behaviors to control said reevaluating and reexecuting of said cells.

28. The method in claim 25, further comprising pushing data from said spreadsheet only after said reevaluating and reexecuting of said cells is complete.

29. The method in claim 25, wherein said mapping of object to interactor components can be performed by a user.

30. The method in claim 25, wherein said interactor components provide rendering and interaction capabilities for command-line interfaces, graphical user interfaces, and form-based web interfaces.

31. The method in claim 25, wherein the layout and the size of the said interactor components can be modified by the user to define the look of the application developed.
